(19) United States
(12) Patent Application Publication
(10) Pub. No.: US 2023/0316159 A1
(43) Pub. Date: Oct. 5, 2023

(54) UTILIZING COMPUTER MODELS TO DYNAMICALLY MATCH PROVIDER DEVICES AND PRIORITY REQUESTER DEVICES IN RESPONSE TO TIME PRIORITY AIRPORT TRANSPORTATION REQUESTS

(71) Applicant: Lyft, Inc., San Francisco, CA (US)

(72) Inventors: Michael Scott Bishoff, San Francisco, CA (US); Andrew Bruce Holbrook, San Francisco, CA (US); Arman Jabbari, Seattle, WA (US); Simon Jack Jenkins, San Francisco, CA (US); David Bruce Lindsay, Kirkland, WA (US); Ding Luo, Seattle, WA (US); Nathan Patrick Green McCloskey, New York, NY (US); Keshav Puranmalka, Seattle, WA (US); Guy-Baptiste Richard de Capele d'Hautpoul, San Francisco, CA (US)

(21) Appl. No.: 17/810,708

(22) Filed: Jul. 5, 2022

Related U.S. Application Data
(60) Provisional application No. 63/362,355, filed on Apr. 1, 2022.

(51) Int. Cl. G06Q 10/02; G06Q 10/06; H04W 4/021; G06Q 50/30

(52) U.S. Cl. CPC G06Q 10/02; G06Q 10/06316; H04W 4/021; G06Q 50/30

(57) ABSTRACT

This disclosure describes an airport priority matching system that can utilize computer implemented models to dynamically match provider devices and priority requester devices in response to time priority airport transportation requests. In particular, in one or more embodiments the airport priority matching system identifies, utilizing global positioning data, provider devices within an airport boundary region and determines time metrics relative to an airport pickup location and/or a ranking order corresponding to an airport provider device tiered staging location. Moreover, prior to receiving a time priority airport transportation request, the airport priority matching system reserves a set of provider devices for airport time priority services based on the plurality of time metrics and/or the ranking order. Further, in response to receiving the time priority airport transportation request, the airport priority matching system selects a provider device from a pool of available provider devices to match to a priority requester device.

### CROSS-REFERENCE TO RELATED APPLICATIONS

This application claims priority to U.S. Provisional Application No. 63/362,355, entitled “UTILIZING COMPUTER MODELS TO DYNAMICALLY MATCH PROVIDER DEVICES AND PRIORITY REQUESTER DEVICES IN RESPONSE TO TIME PRIORITY AIRPORT TRANSPORTATION REQUESTS,” filed Apr. 1, 2022, the full disclosure of which is incorporated herein by reference.

### BACKGROUND

Recent years have seen significant developments in on-demand transportation systems that utilize mobile devices to coordinate across computer networks. Indeed, the proliferation of web and mobile applications has enabled requesting devices to utilize on-demand ride sharing systems to identify matches between provider devices and requester devices and coordinate across computer networks to initiate transportation from one geographic location to another. For instance, conventional transportation network systems can determine geographic locations of provider devices and requester devices, generate digital matches between provider devices and requester devices, and further track, analyze, and manage pick-up, transportation, and drop-off routines through digital transmissions across computer networks. Despite these recent advances, however, conventional transportation network systems continue to exhibit a number of drawbacks and deficiencies, particularly with regard to implementation within congested airport areas.

For example, conventional systems and implementing computing devices suffer from significant operational and accuracy problems within airports. Indeed, airport regions often include a significant number of requester devices and provider devices within a small geographic region. Moreover, airports often include overlapping roadways, terminals, or staging lots, introducing ambiguity as to the location and proximity of provider devices and requester devices. This compact computing device environment makes many conventional approaches to locating, identifying, and matching provider devices and requester devices ineffective. For example, conventional systems within airport environments will often match provider devices on a different terminal level or at incompatible roadways due to the inaccuracy of location and identification technologies within the airport environment.

These technical problems also undermine the flexibility and functional capacity of conventional systems at airports. For example, in addition to the difficulty of identifying and locating various devices, the unique features of identifying matches within airport regions also inhibits matching functionality across provider devices and requester devices. To illustrate, requester devices within airport regions are often located within common geographical areas, such as terminals, which provider devices approach along designated routes or channels. Accordingly, conventional systems within airport regions often function under a rigid first-in-first-out model. Moreover, conventional systems utilize the same first-in-first-out approach regardless of the device imbalances between provider devices and requester devices. This rigid approach, however, undermines flexibility of implementing systems to provide more flexible operational control across provider devices and requester devices. Indeed, conventional systems are often unable to accommodate different transportation request types or generate matches between requester devices and provider devices outside of the rigid first-in-first-out model.

Furthermore, to the extent that conventional systems seek to deviate from the first-in-first-out model they also suffer from a number of computational inefficiencies. For example, conventional systems that match provider devices with requester devices outside of an order of arrival often generate inefficient matches that require significant and inefficient communications between devices over computer networks. To illustrate, as discussed above, conventional systems have difficulty accurately identifying location and orientation within crowded terminal areas at airports. Accordingly, conventional systems that seek to deviate from the first-in-first-out model often generate matches that require significant re-routing instructions and duplicative requests from provider devices and requester devices. Moreover, conventional systems often experience increased cancellation requests, which results in duplicative server matching processes, duplicative instructions to client devices, and duplicative notifications to both provider devices and requester devices. Accordingly, conventional systems suffer from inefficient utilization of computing resources (e.g., memory and processing power), excessive bandwidth utilization, and increased latency.

These, along with additional problems and issues, exist with conventional transportation network systems.

### SUMMARY

This disclosure describes one or more embodiments of methods, non-transitory computer-readable media, and systems that utilize computing models to dynamically match provider devices and priority requester devices in response to time priority airport transportation requests. In particular, in one or more embodiments the disclosed systems utilize global positioning information outside of congested airport terminals to reserve provider devices for time priority airport transportation requests. In some implementations, the airport priority matching system delays matching processes for reserved provider devices to generate efficient, timely transportation matches for priority requester devices that submit time priority airport transportation requests. Depending on the unique features detected at various airports, the airport priority matching system utilizes dynamic approaches to fulfill time priority airport transportation requests, such as intelligent reservation of provider devices at airport provider device tiered staging locations, time-metric-based reservation of pre-dispatch provider devices, dynamic reservation of preliminary matched provider devices according to a priority queue, utilization of flexible time delay airport transportation requests, and/or reservation of unavailable provider devices already associated with requester devices. The airport priority matching system can utilize these approaches as guided by strategically selected global positioning data, threshold reservation radii, threshold reservation timelines, and other reservation guidelines to improve accuracy, flexibility, and efficiency in generating matches across computing devices within airport boundary regions.

### BRIEF DESCRIPTION OF THE DRAWINGS

The detailed description refers to the drawings briefly described below.

FIG. 1 illustrates a block diagram of an environment for implementing a transportation matching system and an airport priority matching system in accordance with one or more embodiments.

FIG. 2 illustrates an example sequence flow for matching a provider device and priority requester device within an airport boundary region in accordance with one or more embodiments.

FIG. 3 illustrates reserving and releasing provider devices for priority transportation services at airport provider device tiered staging locations in accordance with one or more embodiments.

FIG. 4 illustrates reserving pre-dispatch provider devices for priority transportation services within an airport boundary region in accordance with one or more embodiments.

FIG. 5 illustrates reserving provider devices for priority transportation services utilizing flexible time delay airport transportation requests in accordance with one or more embodiments.

FIGS. 6A-6C illustrate reserving provider devices utilizing a priority queue of preliminarily matched provider devices in accordance with one or more embodiments.

FIGS. 7A-7C illustrate reserving different provider devices in response to different circumstances in accordance with one or more embodiments.

FIGS. 8 illustrates utilizing a hyperparameter model to determine hyperparameters for reserving provider devices in accordance with one or more embodiments.

FIG. 9 illustrates selecting and implementing different priority reservation approaches at different airports in accordance with one or more embodiments.

FIG. 10 illustrates an example series of acts for matching provider devices to time priority airport transportation requests in accordance with one or more embodiments.

FIG. 11 illustrates a block diagram of a computing device for implementing one or more embodiments of the present disclosure.

FIG. 12 illustrates an example environment for a transportation matching system in accordance with one or more embodiments.

### DETAILED DESCRIPTION

This disclosure describes one or more embodiments of an airport priority matching system that utilizes computer models to dynamically match provider devices and priority requester devices in response to time priority airport transportation requests. In particular, in one or more embodiments the airport priority matching system provides user interfaces at requester devices to identify and transmit time priority airport transportation requests. In response, the airport priority matching system utilizes a variety of intelligent approaches to generate reduced time transportation matches for the priority airport transportation requests, despite the technical challenges discussed above with regard to airport regions. In particular, the airport priority matching system utilizes global positioning data to reserve provider devices for time priority airport transportation requests (and delay final matching processes based on these reservations) to more flexibly, efficiently, and accurately generate transportation matches within airport boundary regions.

To illustrate, in one or more embodiments, the airport priority matching system utilizes global positioning data to determine provider device features outside of crowded airport terminals. For example, the airport priority matching system utilizes global positioning data to determine time metrics for provider devices relative to an airport pickup location. Similarly, the airport matching system utilizes global positioning data to determine ranking orders for provider devices at airport provider device tiered staging locations. In one or more implementations, the airport priority matching system utilizes these time metrics and/or ranking orders to create a time wedge for priority airport transportation requests. For example, the airport priority matching system reserves provider devices according to the time metrics and ranking orders such that, in response to receiving a priority airport transportation request, the airport priority matching system dynamically matches a priority requester device with a reserved provider device with reduced transit time.

The airport priority matching system can utilize a variety of dynamic approaches to generate transportation matches for time priority airport transportation requests. For example, in one or more embodiments, the airport priority matching system utilizes airport provider device tiered staging locations to generate matches for priority requester devices. In particular, the airport priority matching system utilizes global positioning data to determine a ranking order at an airport provider device tiered staging location and reserves provider devices based on the ranking order. Specifically, in one or more embodiments, the airport priority matching system reserves provider devices for airport time priority services based on an inverse order of arrival for provider devices at the provider device tiered staging location.

In one or more embodiments, the airport priority matching system avoids inefficient provider device utilization by implementing efficiency guardrails at the provider device tiered staging location. For example, in one or more embodiments, the airport priority matching system intelligently cycles through reserved provider devices as additional provider devices enter the provider device tiered staging location. Indeed, by reserving provider devices based on an inverse order of arrival, the airport priority matching system cycles through provider devices to reduce inefficient provider device communications and stagnation. Moreover, in one or more embodiments, the airport priority matching system utilizes a threshold reservation time and dynamically releases provider devices from being reserved by tracking and comparing provider device reservation time at the provider device tiered staging location.

In addition to provider device tiered staging locations, in one or more embodiments the airport priority matching system utilizes pre-dispatch provider devices to generate matches for time priority airport transportation requests. For example, the airport priority matching system pre-dispatches provider devices (e.g., transmits instructions to provider devices to travel to the airport pickup location or an intermediate location) without a matched requester device. While the pre-dispatch provider device is en route, the airport priority matching system reserves a set of provider devices for airport time priority services. Specifically, the airport priority matching system determines time metrics relative to an airport pickup location (e.g., estimated time of arrival) and reserves a set of priority devices based on the time metrics (e.g., the two provider devices with the lowest estimated time of arrival). In response to receiving a time priority airport transportation request, the airport priority matching system matches the priority requester device from a pool of available provider devices (including the reserved, pre-dispatch provider devices).

In one or more embodiments, the airport priority matching system avoids inefficient/inaccurate communications and utilization of pre-dispatch provider devices by enforcing a threshold radius relative to the airport pickup location. For example, the airport priority matching system can utilize global positioning data to determine when pre-dispatch provider devices fall within the threshold radius (e.g., a distance or time radius). If a pre-dispatch provider device that is reserved falls within the threshold radius, the airport priority matching system releases the pre-dispatch provider device, identifies a transportation match (e.g., from a standard requester device), and reserves a different pre-dispatch provider devices outside the threshold radius. In this manner, the airport priority matching system dynamically reserves and releases pre-dispatch provider devices to preserve efficiency while also reserving pre-dispatch provider devices to generate a time improvement for time priority airport transportation requests.

In some embodiments, the airport priority matching system utilizes a preliminary matching approach with priority queuing to generate matches for time priority airport transportation requests. For example, the airport priority matching system determines provider devices (within an airport boundary region) and requester devices (at an airport pickup location) and determines preliminary matches between the provider devices and the requester devices (e.g., a first provider device with a lowest estimated time of arrival has a preliminary match with a first requester device). The airport priority matching system also dispatches the plurality of provider devices to the airport pickup location. Despite the preliminary matching, the airport priority matching system reserves one or more of the provider devices for airport time priority services (e.g., by not displaying match details to the provider devices and/or the requester devices). Thus, the provider devices are reserved within an onhold, dispatch state. Upon receiving a time priority airport transportation request, the airport priority matching system can match one of the reserved, dispatched provider devices to a priority requester device. For instance, the airport priority matching system drops the preliminary match and determines new preliminary matches between the remaining provider devices and the requester devices.

In utilizing this preliminary matching approach, the airport priority matching system can also utilize a threshold radius to convert preliminary matches to final matches (e.g., assign the onhold, dispatched drivers to a standard requester device). For example, upon detecting that a provider device falls within a threshold radius relative to the airport pickup location, the airport priority matching system can finalize a match between a provider device and requester device (e.g., by displaying detailed match information at the provider device and the requester device). In this manner, the airport priority matching system utilizes a priority queue of pre-matched dispatched provider devices to determine matches for time priority airport transportation requests.

Furthermore, in some implementations, the airport priority matching system responds to time priority airport transportation requests by leveraging flexible time delay airport transportation requests. For example, the airport priority matching system receives flexible time delay airport transportation requests that indicate a flexible, future time range for providing transportation services. In one or more embodiments, the airport priority matching system identifies a preliminary match with a flex provider device for the flexible time delay airport transportation request. The airport priority matching system dispatches the flex provider device to the airport pickup location (e.g., together with other preliminary match provider devices discussed above) without disclosing detailed matching information (e.g., withholding information regarding the match from the requester provider device). Upon receiving a time priority airport transportation request, the airport priority matching system can match the flex provider device with the priority requester device (and identify an alternate flex provider device for the flexible time delay airport transportation request).

In addition, in one or more embodiments, the airport priority matching system also leverages unavailable provider devices to respond to time priority airport transportation requests. For example, the airport priority matching system identifies provider devices that are providing transportation services to an airport region (e.g., with a rider as a passenger) and reserves these unavailable provider devices for airport time priority services upon completion of the current ride. For example, the airport priority matching system can identify a plurality of unavailable provider devices (e.g., provider devices currently transporting a requester device), determine time metrics relative to the airport pickup location, and reserve one or more unavailable provider devices for airport time priority services based on the time metrics. In response to receiving a time priority airport transportation request, the airport priority matching system matches a reserved, unavailable provider device to the time priority airport transportation request. When the unavailable provider device becomes available (e.g., completes the current ride), the airport priority matching system then dispatches the provider device to the priority requester device at the airport pickup location.

In some implementations, the airport priority matching system also utilizes a threshold radius with regard to unavailable provider devices. For example, the airport priority matching system reserves unavailable provider devices until determining that the unavailable provider devices fall within the threshold radius. Upon reaching or crossing the threshold radius, the airport priority matching system matches the unavailable provider device to another requester device and reserves a different unavailable provider device that is still located outside the threshold radius.

The airport priority matching system can utilize a variety of computer-implemented models to intelligently determine and implement hyperparameters for matching provider devices to time priority airport transportation requests. For example, in one or more embodiments the airport priority matching system determines airport features (e.g., physical layout, airport regulations) and intelligently determines approaches or algorithms to apply for that particular airport. Moreover, in some implementations, the airport priority matching system utilizes a prediction model to determine other hyperparameters, such as the number of provider devices to reserve for time priority transportation services, the number of provider devices to dispatch to an airport provider device tiered staging location, a number of provider devices to pre-dispatch, a particular distance or time to apply for a threshold radius, and/or a threshold reservation time. For example, in one or more implementations the airport priority matching system utilizes a simulation model, an objective function, and/or a machine learning model to determine these hyperparameters. To illustrate, the airport priority matching system utilizes a computer implemented model to select hyperparameters to reduce time metrics for time priority airport transportation requests subject to constraints on time metrics for other requester devices, time metrics for provider devices, and airport constraining features.

As suggested above, the disclosed airport priority matching system provides several improvements or advantages over conventional systems. For instance, the airport priority matching system can improve accuracy and operational performance relative to conventional systems. Indeed, unlike conventional systems that struggle to identify and determine device locations to generate matches at or near airport terminals, the airport priority matching system can determine and utilize global positioning data outside of congested and geographically complex terminal areas to determine matches for priority requester devices at airport pickup locations. For example, as discussed above, in one or more embodiments the airport priority matching system utilizes global positioning data to determine time metrics outside of a threshold radius of an airport pickup location (and/or ranking orders for provider devices at airport provider device tiered staging locations). The airport priority matching system utilizes these signals to accurately identify and reserve pre-dispatch provider devices, provider devices airport provider device tiered staging locations, preliminary matched provider devices, flexible time delay airport transportation requests, and/or unavailable provider devices to respond to time priority airport transportation requests.

The airport priority matching system also improves flexibility relative to conventional systems. Indeed, rather than relying on rigid first-in-first-out models, the airport priority matching system flexibly and dynamically reserves provider devices and then generates matches (from the pool of available provider devices) with time priority airport transportation requests as they surface from priority requester devices at airport pickup locations. Thus, for example, the airport priority matching system flexibly generates matches for pre-dispatched provider devices or devices already waiting at a nearby airport device tiered staging location to dynamically generate matches specific to the particular transportation requests available at any time. Accordingly, the airport priority matching system can also provide more flexible graphical user interfaces at airports that allow requester devices to select time priority services. Because of the technical problems discussed above, these user interfaces and corresponding options were typically unavailable under conventional systems within airport regional boundaries.

In one or more embodiments, the airport priority matching system also improves flexibility in dynamically responding to different circumstances at airports. Indeed, in one or more embodiments, the airport priority matching system utilizes different approaches depending on device imbalances (e.g., the number of requester devices and/or provider devices within an airport boundary region). Thus, for example, the airport priority matching system can draw from airport provider device tiered staging locations (where the number of provider devices is high relative to the number of requester devices) and automatically transition to drawing from pre-dispatch provider devices (where the number of provider devices is low relative to the number of requester devices). Thus, the airport priority matching system flexibly shifts approaches based on the dynamic balance between requester devices and provider devices.

In addition, the airport priority matching system improves computing efficiency relative to conventional systems. For example, by utilizing global positioning data of provider devices outside of airport terminal regions (e.g., time metrics outside of a threshold radius of an airport pickup location and/or ranking orders for provider devices at airport provider device tiered staging locations) the airport priority matching system generates transportation matches for priority requester devices at airport pickup locations that require fewer re-routing instructions and reduced requests from provider devices and requester devices. Indeed, the airport priority matching system can service time priority airport transportation requests with significantly reduced cancellation requests, routing directions, duplicative matching processes, or duplicative notifications. Thus, the airport priority matching system can reduce utilization of computing resources (e.g., processing power and/or memory) and improve network bandwidth.

As indicated by the foregoing discussion, the present disclosure utilizes a variety of terms to describe features and advantages of the airport priority matching system. For example, as used herein, the term “provider device” refers to a computing device associated with a transportation provider or driver (e.g., a human driver or an autonomous computer system driver) that operates a transportation vehicle. For instance, a provider device refers to a mobile device such as a smartphone or tablet operated by a provider—or a device associated with an autonomous vehicle that drives along transportation routes.

As suggested above, the term “requester device” refers to a computing device associated with a requester that submits a transportation request to a transportation matching system. For instance, a requester device receives interaction from a requester in the form of user interaction to submit a transportation request. After the transportation matching system matches a requester (or a requester device) with a provider (or a provider device), the requester can await pickup by the provider at a predetermined pick-up location. Upon pick-up, the provider transports the requester to a drop-off location specified in the requester's transportation request. Accordingly, a requester may refer to (i) a person who requests a request or other form of transportation but who is still waiting for pickup or (ii) a person whom a transportation vehicle has picked up and who is currently riding within the transportation vehicle to a drop-off location.

As used herein, the term “transportation request” refers to a request from a requesting device (i.e., a requester device) for transport by a transportation vehicle. In particular, a transportation request includes a request for a transportation vehicle to transport a requester or a group of individuals from one geographic area to another geographic area. A transportation request can include information such as a pick-up location, a destination location (e.g., a location to which the requester wishes to travel), a request location (e.g., a location from which the transportation request is initiated), location profile information, a requester rating, or a travel history. As an example of such information, a transportation request may include an address as a destination location and the requester's current location as the pick-up location. A transportation request can also include a requester device initiating a session via a transportation matching application and transmitting a current location (thus, indicating a desire to receive transportation services from the current location).

Moreover, as used herein, the term “time priority airport transportation request” refers to a transportation request for pickup within an airport boundary region that indicates a shortened time period for pickup. In particular, a time priority airport transportation request can include a transportation request that identifies an airport pickup location and a shortened time period for pickup relative to a standard transportation request. Similarly, a priority requester device refers to a requester device associated with (e.g., that submits or transmits) a time priority airport transportation request. As used herein, the term “airport time priority transportation services” refers to utilizing provider devices to respond to time priority airport transportation requests. Thus, reserving provider devices for priority transportation services includes delaying a final transportation match for a provider device so that the provider device can respond to a future/anticipated time priority airport transportation request.

In addition, as used herein, the term global positioning data refers to location information corresponding to a global positioning system. In particular, global positioning data includes digital data reflecting a location of a provider device and/or requester device. For example, provider devices and/or requester devices can communicate with satellites of a global positioning system to determine coordinates of the provider devices and/or requester devices. Moreover, the provider devices and/or requester devices can transmit global positioning data to one or more servers.

Further, as used herein, the term airport boundary region refers to an area that includes an airport. For example, an airport boundary region can include a geofence that encompasses an airport. Similarly, an airport boundary region can include a defined set of roadways leading to or from an airport and pickup locations at the airport.

As used herein, the term “time metric” refers to a measure of time for a provider device to accomplish a task. For example, a time metric relative to a pickup location includes a measure of time to travel to the pickup location. To illustrate, a time metric can include an estimated time of arrival for a provider device at a pickup location.

In addition, as used herein, the term “airport pickup location” refers to a location that a provider device can pick up a requested device at an airport. For example, an airport pickup location can include a designated curb or lot for provider devices to pick up requester devices at an airport. To illustrate, airport pickup locations are often located around airport terminals.

Moreover, as used herein, the term “airport provider device staging location” refers to a location within an airport boundary region where provider devices are able to stop. For example, an airport provider device staging location can include a staging lot where provider devices are able to stop and wait for a transportation match or dispatch. Similarly, the term “airport provider device tiered staging location” refers to an additional airport provider device staging location. In particular, an airport provider device tiered staging location can include a second staging lot, closer to an airport pickup location (relative to an initial airport provider device staging location). For example, many airports include two staging lots, a first staging lot (or staging curb) near the entrance to an airport (e.g., an airport provider device staging location) and a second staging lot (or staging curb) closer to the terminal (e.g., an airport provider device tiered staging location).

As used herein, the term “pre-dispatch provider device” refers to a provider device dispatched to an airport pickup location before identifying a transportation match. In particular, a pre-dispatch provider device includes a provider device dispatched from an airport provider device staging location to an airport pickup location without a matched requester device. In some implementations, the airport priority matching system dispatches a provider device without a match based on an estimated or anticipated requester device to shorten wait times for the estimated or anticipated requester device.

Further, as used herein, the term flexible time delay airport transportation request refers to a transportation request that indicates a delayed pickup time relative to another (e.g., standard or baseline) transportation request. In one or more embodiments, a flexible time delay airport transportation request includes a future time window for a transportation request pickup (e.g., that is later or delayed relative to a standard or baseline pickup time). As used herein, the term “flex requester device” refers to a requester device associated with (e.g., requesting or transmitting) a flexible time delay airport transportation request. Similarly, a “flex provider device” refers to a provider device associated with (e.g., dispatched in response to) a flexible time delay airport transportation request.

In addition, as used herein, the term “preliminary match” refers to an initial transportation match between a provider device and a requester device (e.g., that is subject to change or modification). For example, a preliminary match can include an initial dispatch of a provider device to respond to a transportation from a requester device where the system reserves the provider device for a time priority airport transportation request. Thus, for example, in a preliminary match, the provider device and the requester device may not receive a notification regarding the match (or may not receive certain details regarding the preliminary match, such as identifying information associated with the provider device/requester device). Upon receiving a time priority airport transportation request, the preliminary match may be discarded or dropped.

As used herein, the term “unavailable provider device” refers to a provider device that is not currently available to provide transportation services. For example, an unavailable provider device includes a provider device currently transporting a requester device to a destination.

Moreover, as used herein, the term “prediction model” refers to a computer-implemented model for generating a predicted or anticipated metric. To illustrate, a prediction model can include a computer-implemented model for predicting a number of requester devices or a number of provider devices. In one or more embodiments, a prediction model includes a machine learning model. As used herein, the term “machine learning model” refers to a computer algorithm or a collection of computer algorithms that automatically improve for a particular task through experience based on use of data. For example, a machine learning model can utilize one or more learning techniques to improve in accuracy and/or effectiveness. Example machine learning models include various types of decision trees, support vector machines, Bayesian networks, linear regressions, logistic regressions, random forest models, or neural networks.

As mentioned above, the airport priority matching system can utilize a prediction model (e.g., a hyperparameter model) to determine hyperparameters for reserving provider devices for time priority airport transportation requests. As used herein a hyperparameter model includes a computer-implemented model for predicting hyperparameters. To illustrate, a hyperparameter model can include a machine learning model, simulator model, and/or objective function for determining hyperparameters (e.g., number of provider devices to reserve, number of providers to dispatch to airport provider device tiered staging locations, number of provider devices to pre-dispatch, threshold reservation radius, threshold reservation time, etc.).

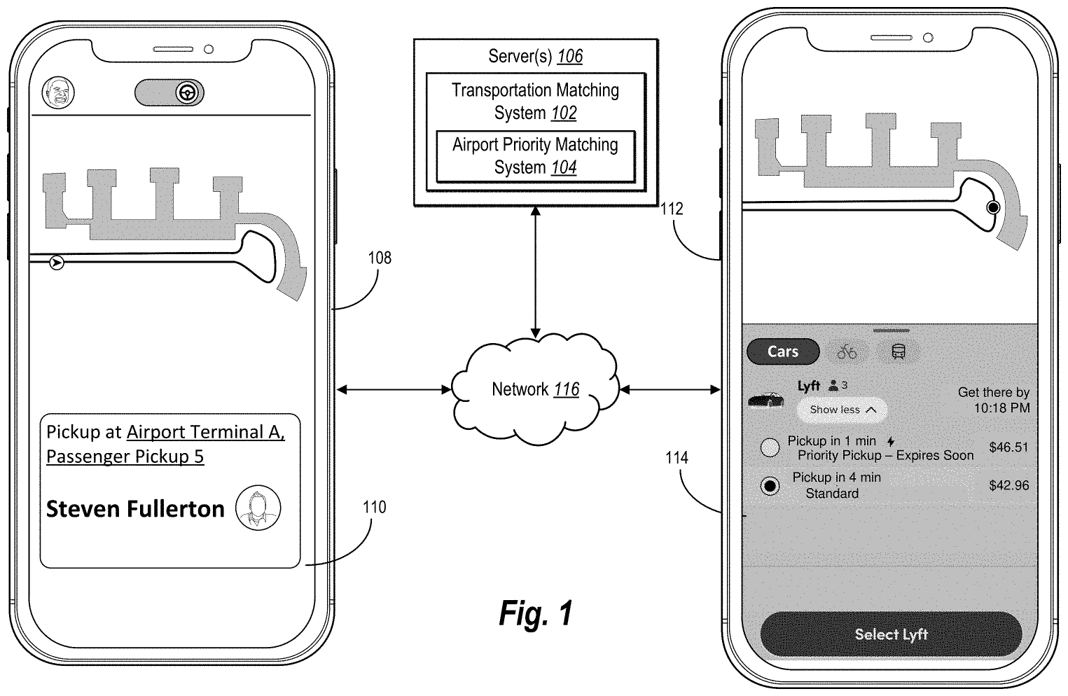

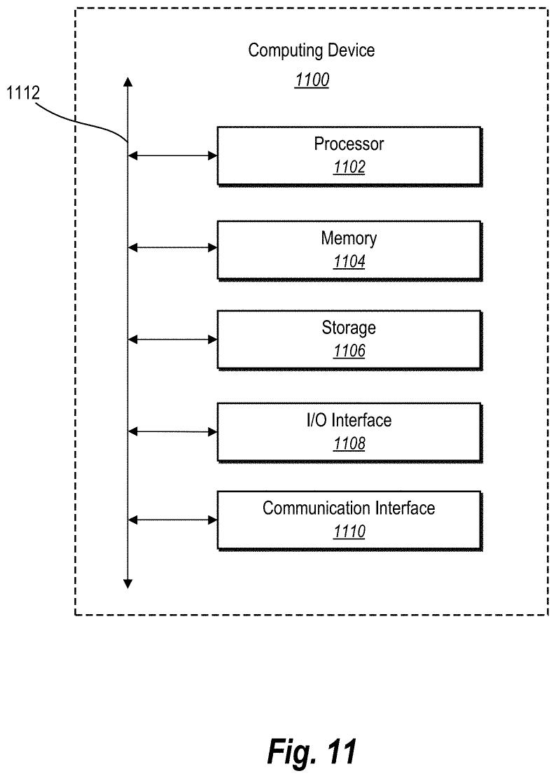

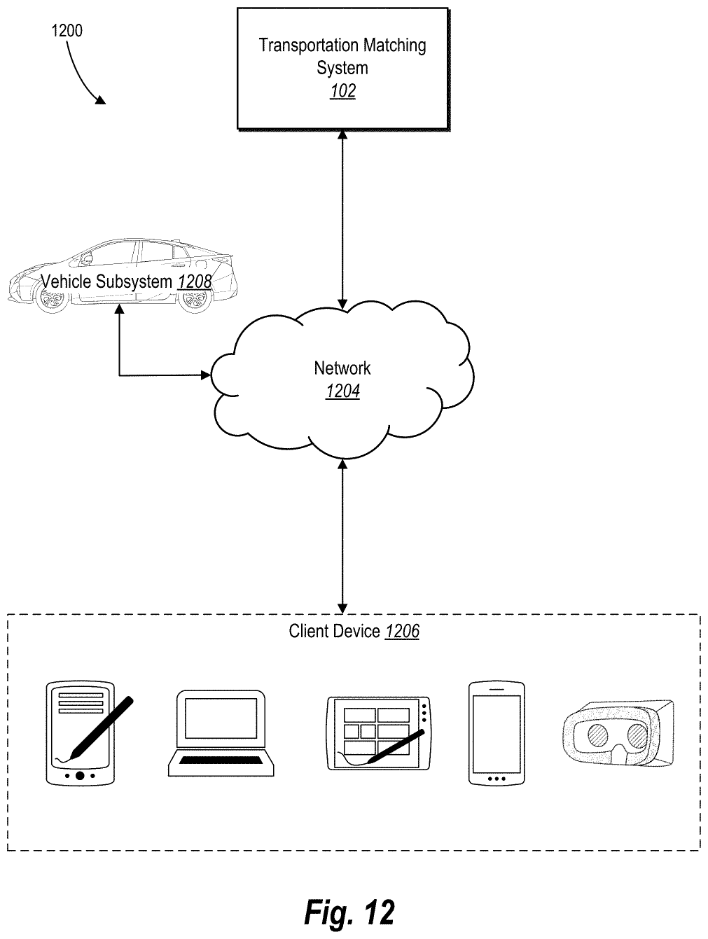

Additional detail regarding the airport priority matching system will now be provided with reference to the figures. In particular, FIG. 1 illustrates a block diagram of a system environment for implementing an airport priority matching system 104 in accordance with one or more embodiments. As shown in FIG. 1, the environment includes server(s) 106 housing the airport priority matching system 104 as part of a transportation matching system 102. The environment of FIG. 1 further includes a provider device 108 (including a provider application 110) and a requester device 112 (including a requester application 114), as well as a network 116. The server(s) 106 can include one or more computing devices to implement the airport priority matching system 104. Additional detail regarding the illustrated computing devices (e.g., the server(s) 106, the provider devices 108, and/or the requester device 112) is provided with respect to FIGS. 11-12 below.

As shown, the airport priority matching system 104 utilizes the network 116 to communicate with the provider device 108 (and other provider devices) and the requester device 112 (and other requester devices). The network 116 may comprise any network described in relation to FIGS. 11-12. For example, the airport priority matching system 104 communicates with the provider device 108 (and other provider devices) and the requester device 112 to match transportation requests received from the requester device 112 with the provider device 108 (or another provider device). Indeed, the transportation matching system 102 or the airport priority matching system 104 can receive a transportation request from the requester device 112 and can provide request information to various provider device, such as a requested location (e.g., a requested pickup location and/or a requested drop-off location), a requester identification (for a requester corresponding to the requester device 112), and a requested pickup time. In some embodiments, per device settings, the transportation matching system 102 or the airport priority matching system 104 receives device information from various provider devices and the requester device 112, such as location coordinates (e.g., latitude, longitude, and/or elevation), orientations or directions, motion information, and indications of user interactions with various interface elements.

To facilitate connecting requests with transportation vehicles, in some embodiments, the transportation matching system 102 or the airport priority matching system 104 communicates with the provider device 108 and other provider devices (e.g., through a provider application 110). As indicated by FIG. 1, the provider device 108 includes the provider application 110. In many embodiments, the transportation matching system 102 or the airport priority matching system 104 communicates with the provider device 108 through the provider application 110 to, for example, receive and provide information including location data, motion data, transportation request information (e.g., pickup locations and/or drop-off locations), and transportation route information for navigating to one or more designated locations.

Similarly, the transportation matching system 102 or the airport priority matching system 104 communicates with the requester device 112 (e.g., through the requester application 114) to facilitate connecting requests with transportation vehicles. In many embodiments, the airport priority matching system 104 communicates with the requester device 112 through the requester application 114 to, for example, receive and provide information including location data, motion data, transportation request information (e.g., requested locations), and navigation information to guide a requester to a designated location.

As indicated above, the transportation matching system 102 or the airport priority matching system 104 can provide (and/or cause the provider device 108 to display or render) visual elements within a graphical user interface associated with the provider application 110 and the requester application 114. For example, the transportation matching system 102 or the airport priority matching system 104 can provide a digital map for display on the provider device 108 that illustrates a transportation route to navigate to a designated location. The airport priority matching system 104 can also provide a transportation request notification for display on the provider device 108 indicating a transportation request.

Moreover, as illustrated the airport priority matching system 104 provides a user interface via the requester device 112 that includes selectable options for various types of transportation requests (e.g., a standard transportation request type, a time priority airport transportation request type, and/or a flexible time delay airport transportation request type). To illustrate, the selectable option for a time priority airport transportation request type includes a reduced time for pickup relative to the other types of transportation requests. In response to selection of the option corresponding to the time priority airport transportation type, the airport priority matching system 104 generates a time priority airport transportation. Moreover, the airport priority matching system 104 identifies a provider device to match to the requester device 112. In addition, the airport priority matching system 104 can provide a digital map for display on the requester device 112, where the digital map illustrates transportation routes.

The airport priority matching system 104 selects one or more provider devices as a recipient for a transportation request received from the requester device 112 based on various factors. Such factors may include a provider device status, time metrics, ranking orders, provider incentives, requester incentives, a time of day, traffic information, and/or other transportation matching considerations.

Although FIG. 1 illustrates the environment having a particular number and arrangement of components associated with the airport priority matching system 104, in some embodiments, the environment may include more or fewer components with varying configurations. For example, in some embodiments, the transportation matching system 102 or the airport priority matching system 104 can communicate directly with the provider device 108 and/or the requester device 112, bypassing the network 116. In these or other embodiments, the transportation matching system 102 or the airport priority matching system 104 can be housed (entirely on in part) on the provider device 108 and/or the requester device 112. Additionally, the transportation matching system 102 or the airport priority matching system 104 can include or communicate with a database for storing information, such as various machine learning models, historical data (e.g., historical provider device and/or requester device patterns), transportation requests, and/or other information described herein.

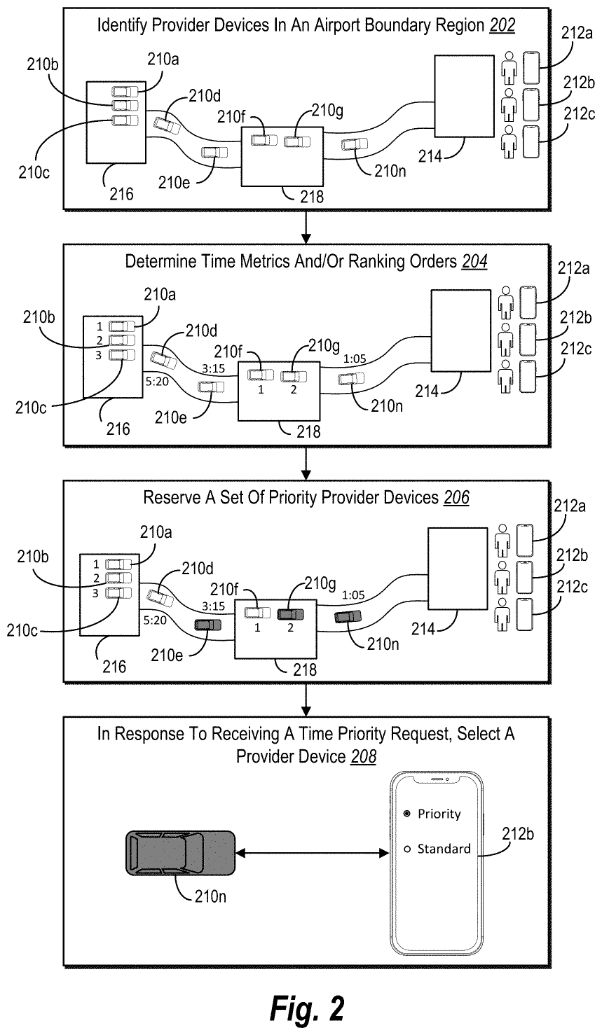

As mentioned, in certain embodiments, the airport priority matching system 104 intelligently selects provider devices to improve response times for time priority airport transportation requests. For example, FIG. 2 illustrates selecting a provider device in response to a time priority airport transportation request in accordance with one or more embodiments.

Specifically, FIG. 2 illustrates the airport priority matching system 104 performing an act 202 of identifying provider devices in an airport boundary region. For example, the airport priority matching system 104 performs the act 202 by monitoring global positioning data from provider devices and identifying provider devices that fall within an airport boundary region (e.g., a geofence encompassing an airport). In one or more embodiments, the airport priority matching system 104 identifies the airport boundary region to include an area or roads beyond the geographic limitations of an airport. For example, the airport boundary region can include a geofence defining an airport and an additional buffer region (e.g., roads within one mile of the geofence). Thus, the airport boundary region can include an airport and roads/areas within a proximity or threshold of the airport. As mentioned above, in one or more embodiments the airport priority matching system 104 intelligently focuses on more accurate global positioning data outside of particular crowded regions or areas. In particular, the airport priority matching system 104 identifies provider devices outside of a threshold radius of an airport pickup location (e.g., an airport terminal), where the global positioning data has increased reliability and accuracy.

Similarly, the airport priority matching system 104 utilizes global positioning data to identify provider devices at airport provider device staging locations (and/or airport provider device tiered staging locations). In some embodiments, the airport priority matching system 104 identifies provider devices at airport provider device staging locations utilizing global positioning data and motion data. For example, the airport priority matching system 104 identifies global positioning data indicating a provider device traveling in a direction toward an airport provider device staging location (where global positioning data is within a high-reliability area). Moreover, the airport priority matching system 104 utilizes global positioning data and motion data to determine that the provider device has stopped. The airport priority matching system 104 utilizes motion data and global positioning data to determine that the provider device has stopped at an airport provider device staging location based on these signals (e.g., even where the provider device staging location may itself fall within an unreliable area for GPS signals).

Thus, as shown in FIG. 2, the airport priority matching system 104 identifies a plurality of provider devices 210a-210n within an airport boundary region. As illustrated, the airport priority matching system 104 identifies various locations and characteristics for the provider devices 210a-210n. For example, the airport priority matching system 104 identifies the provider devices 210a-210c at an initial airport provider device staging location 216. Similarly, the airport priority matching system 104 identifies pre-dispatched provider devices 210d, 210c. Moreover, the airport priority matching system 104 identifies the provider devices 210f, 210g at an airport provider device tiered staging location 218. In addition, the airport priority matching system 104 identifies an unavailable provider device 210n transporting a requester device to a destination within the airport boundary region. Although not illustrated, the airport priority matching system 104 can also identify a priority queue of provider devices with preliminary matches and/or flex provider devices.

Moreover, as illustrated, the airport priority matching system 104 identifies a plurality of requester devices 212a-212c at an airport pickup location 214. Specifically, the airport priority matching system 104 utilizes global positioning data and/or airport data to determine that the plurality of requester devices 212a-212c are at the airport pickup location 214. For example, the airport priority matching system 104 compares the global positioning data with known coordinates of an airport terminal/curb/pickup location to determine that the plurality of requester devices 212a-212c are at the airport pickup location 214.

As illustrated in FIG. 2, the airport priority matching system 104 also performs an act 204 of determining time metrics and/or ranking orders corresponding to the provider devices. For example, the airport priority matching system 104 determines a time metric (e.g., estimated time of arrival or ETA) relative to the airport pickup location 214 for one or more provider devices. Thus, as shown, the airport priority matching system 104 identifies a first time metric (5:20) for the provider device 210d, a second time metric (3:15) for the provider device 210e, and a third time metric (1:05) for the provider device 210n.

The airport priority matching system 104 determines the time metric based on the global positioning data and routes determined between a current location and the airport pickup location 214. For example, the airport priority matching system 104 identifies a current location of each provider device, determines a route between the current location and the airport pickup location 214, and determines an estimated time to travel along the route. The time metric can include estimates that include current driving conditions, weather conditions, traffic, accidents, or other incidents that will impact travel time.

As illustrated in FIG. 2, the airport priority matching system 104 also determines ranking orders for airport provider device staging locations. For example, the airport priority matching system 104 determines a first ranking order for the initial airport provider device staging location 216. Specifically, the airport priority matching system 104 determines a first ranking (i.e., 1) for the provider device 210a, a second ranking (i.e., 2) for the provider device 210b, and a third ranking (i.e., 3) for the provider device 210c.

Similarly, the airport priority matching system 104 determines a second ranking order for the airport provider device tiered staging location 218. In particular, the airport priority matching system 104 determines a first ranking (i.e., 1) for the provider device 210f and a second ranking (i.e., 2) for the provider device 210g.

The airport priority matching system 104 determines the ranking orders based on arrival order at the particular airport provider device staging locations. For example, the ranking orders illustrated in FIG. 2 illustrate the order in which the provider devices arrived at the airport provider device staging location 216 and the airport provider device tiered staging location 218. The airport priority matching system 104 determines the arrival order utilizing global positioning data. For example, the airport priority matching system 104 monitors global positioning data from each of the provider devices and determines a time stamp corresponding to a location of the airport provider device staging locations. The airport priority matching system 104 then ranks the provider devices based on the timestamps.

As illustrated in FIG. 2, the airport priority matching system 104 also performs an act 206 of reserving a set of provider devices. In particular, the airport priority matching system 104 reserves the set of provider devices based on the time metrics and/or ranking orders (as determined at the act 204). For example, in one or more embodiments, the airport priority matching system 104 determines a number of provider devices to reserve for time priority airport transportation services. The airport priority matching system 104 also determines a priority order with regard to different categories/types of provider devices. The airport priority matching system 104 reserves the number of provider devices utilizing the time metrics and/or ranking orders according to the priority order for the different types of provider devices.

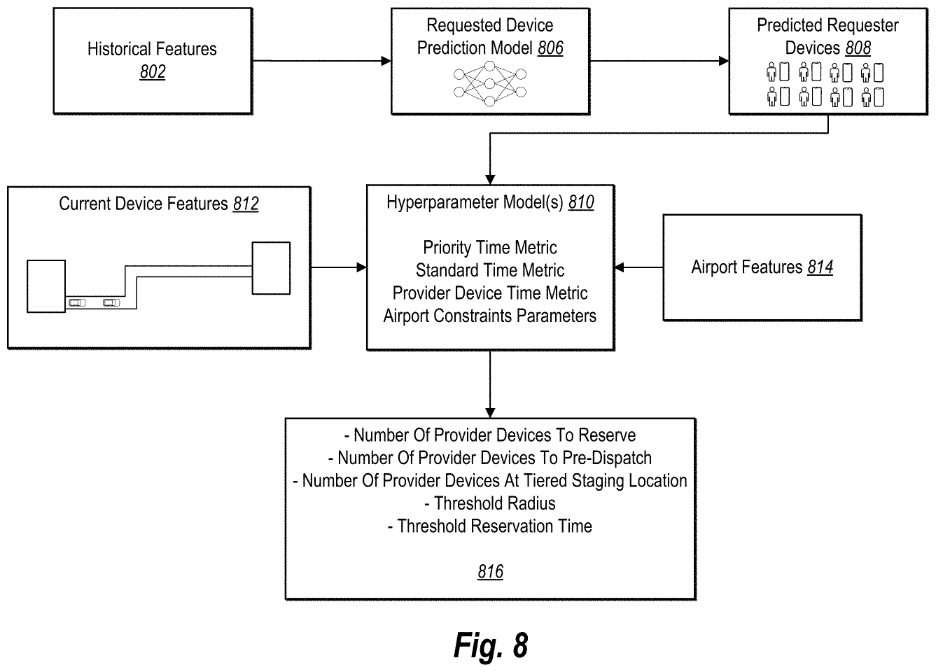

To illustrate, in relation to FIG. 2, the airport priority matching system 104 determines a number of provider devices to reserve (i.e., 3). As discussed in greater detail below (e.g., in relation to FIG. 8), the airport priority matching system 104 can determine the number of provider devices to reserve based on a predicted, estimated, or measured number of requester devices (e.g., predicted priority requester devices). The airport priority matching system 104 can also determine the number of provider devices to reserve based on predicted or measured provider devices (e.g., the number of provider devices at the airport provider device tiered staging location) and/or airport features (e.g., number of provider devices possible to fit at the airport provider device tiered staging location). For example, in one or more embodiments, the airport priority matching system 104 selects the number of provider devices to reserve to exceed the number of estimated/anticipated priority requester devices without exceeding a threshold number (e.g., the total number) of provider devices or a threshold number of provider devices within a particular category (e.g., without exceeding as the number of provider devices at the airport provider device tiered staging location).

As mentioned, the airport priority matching system 104 can also determine a priority order of types/categories of provider devices. For example, in one or more embodiments, the airport priority matching system 104 ranks provider device types/categories in the following priority order: (1) provider devices at the airport provider device tiered staging location, (2) pre-dispatched provider devices, (3) provider devices at the initial airport provider device staging location. The airport priority matching system 104 reserves provider devices form the first category (if available), then the second category (if available), then the third category (if available).

The airport priority matching system 104 can determine a priority order for types/categories based on a variety of factors. For example, in some embodiments, the airport priority matching system 104 selects the priority order based on time or distance from an airport pickup location. Specifically, the airport priority matching system 104 analyzes types/categories of provider devices that are closer to the airport pickup location before analyzing types/categories of provider devices that are further away. In some embodiments, the airport priority matching system 104 selects the priority based on historical data (e.g., historical data indicating which category results in the greatest time improvement for priority requester devices).

The airport priority matching system 104 can utilize a variety of different orders for provider device types/categories. For example, the airport priority matching system 104 can prioritize unavailable provider devices before provider devices at the airport provider device tiered staging location. Similarly, the airport priority matching system 104 can also prioritize provider devices with a preliminary match and/or flex provider devices. The airport priority matching system 104 can prioritize these categories/types in any arrangement depending on the embodiment.

Thus, as illustrated in FIG. 2, the airport priority matching system 104 utilizes the following priority order for categories/types of provider devices: (1) unavailable provider devices closer than the airport provider device tiered staging location, (2) provider devices at the airport provider device tiered staging location, (3) pre-dispatched provider devices, and (4) provider devices at the initial airport provider device staging location.

The airport priority matching system 104 also places limits on the number of each category/type to reserve. The airport priority matching system 104 can utilize a variety of different limits or thresholds (e.g., a number or percentage of provider devices). For example, the airport priority matching system 104 limits the number of provider devices at the airport provider device tiered staging location to 50% of provider devices at the airport provider device tiered staging location (e.g., 1 provider device).

Thus, applying these parameters, the airport priority matching system 104 reserves the unavailable provider device 210n. The airport priority matching system 104 also reserves the provider device 210g (e.g., the provider device with the highest/latest rank based on arrival order at the airport provider device tiered staging location). The airport priority matching system 104 does not reserve any additional provider devices at the airport provider device tiered staging location because the threshold/limit for this category/type is satisfied. The airport priority matching system 104 also reserves the provider device 210e (e.g., the pre-dispatched provider device with the lowest ETA). The airport priority matching system 104 does not reserve any additional provider devices because the total number of reserved provider devices is satisfied.

As illustrated in FIG. 2, the airport priority matching system 104 also performs an act 208 of selecting a provider device in response to receiving a time priority request. In particular, the airport priority matching system 104 receives a time priority request from the requester device 212b. Specifically, the airport priority matching system 104 receives an indication that the requester device 212b selects an option within a graphical user interface indicating a time priority airport transportation request type.

In response, the airport priority matching system 104 selects a provider device from a pool of available provider devices (e.g., the set of provider devices reserved at the act 206 and any additional provider devices available within the airport boundary region). In one or more embodiments, the airport priority matching system 104 analyzes available provider devices within the airport boundary region and selects the provider device with the lowest time metric (or lowest rank order at a staging lot or airport provider device tiered staging location). In some implementations, the airport priority matching system 104 selects provider devices based on a provider time metric (e.g., selects provider devices that have been waiting longest when the ETA is the same or similar between two provider devices, such as at the same staging lot or tiered queue). Thus, the airport priority matching system 104 reserves provider devices to ensure that provider devices are available for a priority transportation request, but analyzes the entire pool of available provider devices (including the reserved priority devices and other devices) to identify a transportation match.

In some implementations, the airport priority matching system 104 selects provider devices from a set of reserved provider devices and utilizes the priority order of the categories/types of provider devices to select the provider device to fulfill the time priority airport transportation request. For example, the airport priority matching system 104 utilizes the unavailable provider device in the highest category/type and selects an unavailable provider device to fulfill a time priority airport transportation request.

Moreover, the airport priority matching system 104 also utilizes time metrics and ranking orders (from the act 204) to select the provider device to fulfill the time priority airport transportation request. However, in some embodiments, the airport priority matching system 104 utilizes an opposite ranking order for determining a transportation match for a provider device relative to reserving a provider device. For example, in an example circumstance where two provider devices are reserved at the airport provider device tiered staging location 218, the airport priority matching system 104 can select the lowest/earliest ranked provider device to fulfill the time priority airport transportation request (instead of the highest/latest ranked provider device reserved at the act 204). Thus, the airport priority matching system 104 can reserve provider devices based on a “last in” approach while generating transportation matches based on a “first in” approach. Similarly, in an example circumstance where two pre-dispatched provider devices are reserved, the airport priority matching system 104 can select the provider device with the lowest time metric (e.g., the lowest ETA).

Although FIG. 2 illustrates a static reservation of provider devices, in one or more embodiments, the airport priority matching system 104 dynamically reserves and releases provider devices over time. For example, the airport priority matching system 104 releases provider devices and reserves other provider devices as additional provider devices enter an airport provider device tiered staging location. Similarly, the airport priority matching system 104 releases provider devices that get too close to the airport pickup location 214 without a transportation match (e.g., when provider devices cross a threshold radius relative to the airport pickup location 214). In addition, the airport priority matching system 104 tracks reserved time for provider devices and releases provider devices when the provider devices satisfy a threshold reservation time.

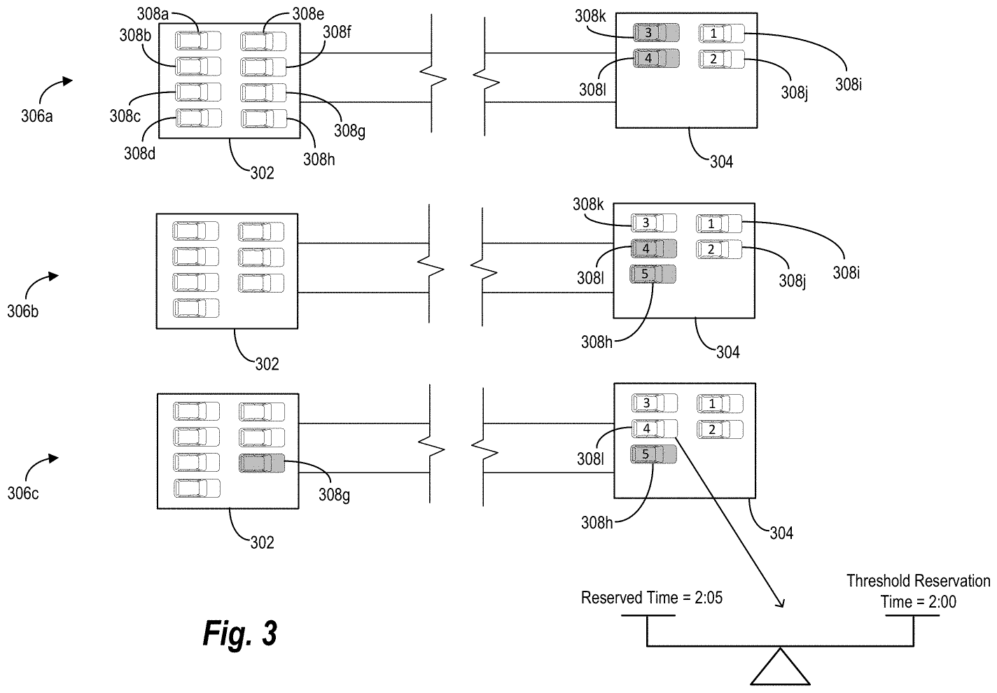

For example, FIG. 3 illustrates reserving and releasing provider devices at an airport provider device tiered staging location. In particular, FIG. 3 illustrates an airport provider device staging location 302 and an airport provider device tiered staging location 304 at three times 306a, 306b, and 306c. As illustrated, the airport priority matching system 104 also identifies provider devices 308a-308l at the airport provider device staging location 302 and the airport provider device tiered staging location 304.

At the first time 306a, the airport priority matching system 104 identifies eight provider devices 308a-308h at the airport provider device staging location 302. Moreover, the airport priority matching system 104 identifies four provider devices 308i-308l at the airport provider device tiered staging location 304. Moreover, the airport priority matching system 104 identifies a ranking order (e.g., an arrival order) of the provider devices 308i-308k. Specifically, the airport priority matching system 104 determines that the provider device 308i arrived first, the provider device 308j arrived second, the provider device 308k arrived third, and the provider device 3081 arrived fourth.

Moreover, as shown, the airport priority matching system 104 selects provider devices to reserve for priority airport transportation services based on the ranking order. In particular, the airport priority matching system 104 selects provider devices 308k, 308l to reserve because they are the highest/latest ranking of the provider devices at the airport provider device tiered staging location 304.

As shown, at the second time 306b, an additional provider device has entered the airport provider device tiered staging location 304. In particular, the provider device 308h travels from the airport provider device staging location 302 to the airport provider device tiered staging location 304. As shown, the airport priority matching system 104 dynamically releases and reserves provider devices in response to this change.

In particular, the airport priority matching system 104 determines a new ranking order reflecting the provider device 308h. Specifically, the airport priority matching system 104 determines that the provider device 308h is the fifth provider device to arrive at the airport provider device tiered staging location 304. Moreover, the airport priority matching system 104 identifies new provider devices to reserve. For example, the airport priority matching system 104 reserves the two highest/latest provider devices at the airport provider device tiered staging location 304. Because the provider device 308h recently arrived, the airport priority matching system 104 reserves the provider devices 308h and 308l.

Moreover, the airport priority matching system 104 determines that the provider device 308k is no longer one of the top two ranked provider devices at the airport provider device tiered staging location 304. In response, the airport priority matching system 104 releases the provider device 308k from being reserved for priority airport transportation services. In particular, being released indicates that the provider device 308k is no longer reserved. That is, the provider device is available to be matched to a non-priority transportation request (e.g., a standard or baseline transportation request).

Accordingly, the airport priority matching system 104 can dynamically monitor provider devices entering or leaving the airport provider device tiered staging location 304, determine rankings, and reserve or release provider devices based on the rankings. Indeed, although the example embodiment at the time 306b of FIG. 3 illustrates a new provider entering the airport provider device tiered staging location 304, the airport priority matching system 104 can also modify reserved provider devices in response to a provider device leaving the airport provider device tiered staging location 304 (e.g., in response to the provider device 308l being assigned to a time priority airport transportation request).

In addition, in one or more embodiments, the airport priority matching system 104 also releases provider devices based on reserved time. Indeed, FIG. 3 illustrates the airport priority matching system 104 at a third time 306c upon expiration of a reserved time for the provider device 3081. Specifically, the airport priority matching system 104 monitors reserved time for the provider device 3081. For example, the airport priority matching system 104 determines a reservation timestamp corresponding to when the airport priority matching system 104 first reserved the provider device 308l for time priority airport transportation services. The airport priority matching system 104 determines a difference between the reservation timestamp and a current time to determine the reserved time. Moreover, as shown, the airport priority matching system 104 compares the reserved time to a threshold reservation time.

For instance, in relation to FIG. 3, the airport priority matching system 104 determines that the provider device 308l has a reserved time of 2:05 (i.e., the airport priority matching system 104 has reserved the provider device 308l for time priority airport transportation services for two minutes and five seconds). The airport priority matching system 104 compares the reserved time to a threshold reservation time of 2:00. In response to determining that the reserved time exceeds the threshold reservation time, the airport priority matching system 104 releases the provider device 308l from being reserved for time priority airport transportation services (e.g., so that the provider device 308l is eligible to be matched to standard or baseline transportation requests). As shown, upon releasing the provider device 308l, the airport priority matching system 104 reserves an additional provider device (i.e., the provider device 308g).

Although FIG. 3 illustrates a threshold reservation time particular to the airport provider device tiered staging location, the airport priority matching system 104 can apply threshold reservation times to other circumstances. For example, in one or more embodiments, the airport priority matching system 104 applies a global threshold reservation time such that the airport priority matching system 104 releases any provider devices with a reserved time that exceeds the threshold reservation time (regardless of category/type). Similarly, in some embodiments, the airport priority matching system 104 applies a different threshold reservation time to the airport provider device staging location 302.

In addition, although FIG. 3 illustrates ranking and reserving provider devices at the airport provider device tiered staging location 304, in one or more embodiments the airport priority matching system 104 performs a similar process with regard to the airport provider device staging location 302. Indeed, the airport priority matching system 104 can determine an arrival order, rank provider devices, reserve provider devices, and dynamically adjust (e.g., release or reserve additional provider devices) over time.

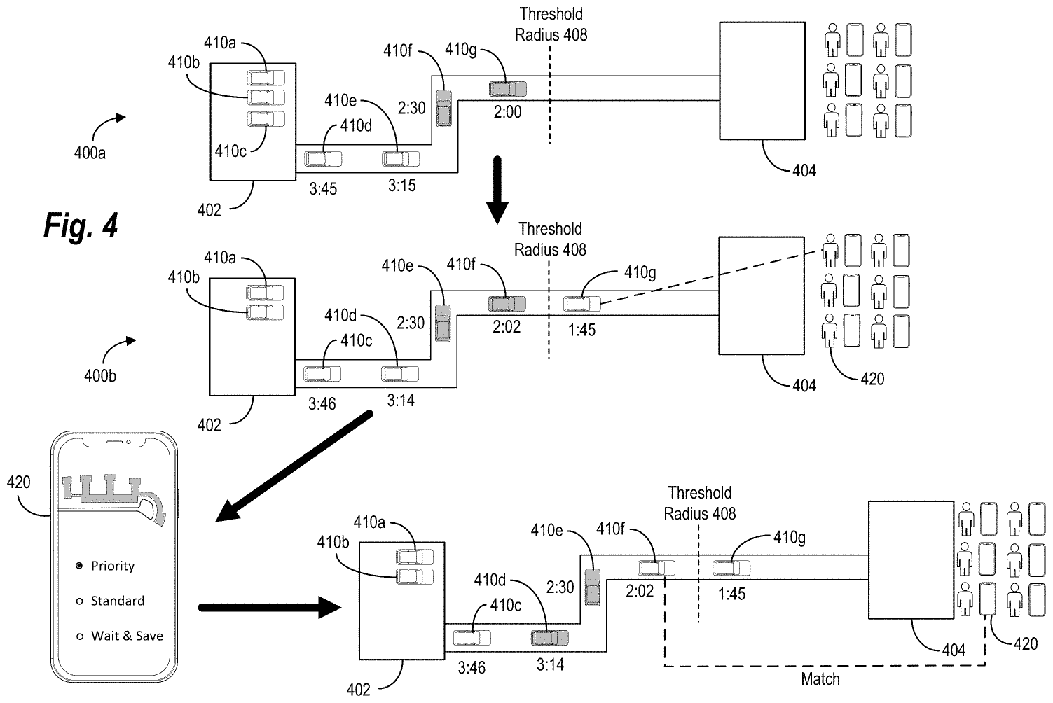

As mentioned above, in one or more embodiments, the airport priority matching system 104 also utilizes pre-dispatch provider devices to fulfill time priority airport transportation requests. For example, FIG. 4 illustrates reserving pre-dispatch provider devices for time priority airport transportation services in accordance with one or more embodiments.

Specifically, FIG. 4 illustrates a plurality of provider devices 410a-410g. As shown, three of the provider devices 410a-410c are waiting at an airport provider device staging lot 402. Moreover, at a first time 400a, FIG. 4 illustrates four pre-dispatched provider devices 410d-410g. These pre-dispatched provider devices are travelling toward an airport pickup location 404. The airport priority matching system 104 transmits instructions for the pre-dispatched provider devices 410d-410g to travel to the airport pickup location 404 without a transportation match at the airport pickup location 404. Indeed, the airport priority matching system 104 predicts or estimates a number of requester devices at the airport pickup location 404 and transmits instructions for the pre-dispatch provider devices 410d-410g to travel to the airport pickup location.

While the pre-dispatch provider devices travel to the airport pickup location 404, the airport priority matching system 104 identifies a set of provider devices to reserve for time priority airport transportation services. In particular, as discussed above, the airport priority matching system 104 reserves the set of provider devices based on time metrics relative to the airport pickup location 404 (e.g., estimated time of arrival or travel time). For example, as shown, the airport priority matching system 104 determines a first time metric (i.e., 2:00 travel time) for the pre-dispatch provider device 410g, a second time metric (i.e., 2:30 travel time) for the pre-dispatch provider device 410f, a third time metric (i.e., 3:15 travel time) for the pre-dispatch provider device 410e, and a fourth time metric (i.e., 3:45 travel time) for the pre-dispatch provider device 410d.

The airport priority matching system 104 reserves provider devices from the pre-dispatch provider devices based on the time metrics. For example, the airport priority matching system 104 determines a number of provider devices to reserve (i.e., 2 provider devices). The airport priority matching system 104 then reserves the number of provider devices with the lowest time metrics. Thus, as shown, the airport priority matching system 104 reserves the pre-dispatch provider devices 410f, 410g.

As shown in FIG. 4, the airport priority matching system 104 also applies a threshold radius 408 in reserving the pre-dispatch provider devices. In particular, the airport priority matching system 104 determines whether pre-dispatch provider devices fall outside or within the threshold radius 408. As illustrated, the airport priority matching system 104 determines that the provider devices 410f, 410g fall outside the threshold radius 408. Accordingly, the airport priority matching system 104 reserves the pre-dispatch provider devices 410f, 410g. If the airport priority matching system 104 determines that the pre-dispatch provider devices 410f, 410g are within the threshold radius (e.g., closer to the airport pickup location 404 than the threshold radius 408), the airport priority matching system 104 would not reserve the pre-dispatch provider devices 410f, 410g.

The threshold radius 408 can include a variety of metrics indicating a time or distance relative to an airport pickup location. For example, in some embodiments, the threshold radius 408 is a distance (e.g., one mile) from the airport pickup location 404. In some embodiments, the threshold radius 408 is a threshold estimated time of arrival or a threshold travel time. To illustrate, once an estimated travel time falls below a threshold travel time (i.e., the threshold radius), the airport priority matching system 104 will not reserve the pre-dispatch provider device.

In one or more embodiments, the airport priority matching system 104 applies a threshold radius to release provider devices as they approach an airport pickup location. For example, FIG. 4 illustrates a second time 400b, where the provider devices have changed locations. In particular, the airport priority matching system 104 pre-dispatches the provider device 410c from the airport provider device staging lot 402. The airport priority matching system 104 also determines a time metric for the provider device 410c (i.e., 3:46) relative to the airport pickup location 404.

The pre-dispatch provider devices 410d-410g have also changed positions and drawn closer to the airport pickup location 404. As shown, the pre-dispatch provider device 410g has passed the threshold radius 408 (e.g., the travel time to the airport pickup location 404 is below a threshold travel time). In response, the airport priority matching system 104 releases the provider device 410g. Moreover, the airport priority matching system 104 determines a transportation match between the provider device 410g and a requester device (e.g., a standard requester device).

Moreover, as shown, the airport priority matching system 104 reserves a revised set of provider devices. Specifically, the airport priority matching system 104 utilizes global positioning data to determines new time metrics relative to the airport pickup location 404. The airport priority matching system 104 then reserves the number of provider devices based on the new time metrics (e.g., the two pre-dispatch providers with the lowest ETA or travel time). Thus, as shown, the airport priority matching system 104 reserves the pre-dispatch provider devices 410e, 410f.

As mentioned previously, in one or more embodiments the airport priority matching system 104 assigns a provider device from a pool of available provider devices to fulfill a time priority airport transportation request. In response to assigning a reserved provider device, the airport priority matching system 104 reserves other provider devices. For example, FIG. 4 illustrates a priority requester device 420. As shown, the priority requester device 420 initiates a time priority airport transportation request. In response, the airport priority matching system 104 analyzes the pool of available provider devices (e.g., all unmatched provider devices or provider devices predicted to be available within a threshold time period) and determines a transportation match. For example, the airport priority matching system 104 analyzes available provider devices and generates a transportation match based on time metrics (e.g., the lowest ETA) or ranking orders (e.g., first provider device at a tiered queue or staging lot). In relation to FIG. 4, the airport priority matching system 104 performs this analysis and matches the pre-dispatch provider device 410f to the priority requester device 420.

Specifically, the airport priority matching system 104 analyzes the reserved pre-dispatch provider devices 410e, 410f (because the provider device 410g is no longer available) to determine a match for the priority requester device 420. For example, the airport priority matching system 104 compares time metrics for the reserved pre-dispatch provider devices 410e, 410f and selects the pre-dispatch provider device based on the comparison (e.g., selects the pre-dispatch provider with the lowest time metric).

Notably, the pre-dispatch provider device 410f is significantly nearer to the airport pickup location 404 than the provider devices 410a-410e. Thus, the pre-dispatch provider device 410f is able to efficiently fulfill the time priority airport transportation request. Moreover, the pre-dispatch provider device 410f is still outside the threshold radius 408 so that the airport priority matching system 104 has access to more accurate and certain global positioning data. In addition, the airport priority matching system 104 has sufficient time to assign the pre-dispatch provider device 410g to a standard provider device before the pre-dispatch provider device 410g arrives at the airport pickup location 404.

In some implementations, the airport priority matching system 104 performs swaps from provider devices previously matched to requester devices. For example, in response to receiving a priority transportation request, the airport priority matching system 104 changes a transportation match. Thus, for example, although not illustrated in FIG. 4 in such an embodiment the airport priority matching system 104 removes the transportation match from the provider device 410g and assigns the provider device 410g to the time priority airport transportation request in a new transportation match.

In addition to selecting the pre-dispatch provider device to match to the priority requester device 420, the airport priority matching system 104 also reserves a new set of provider devices. Indeed, as shown in FIG. 4, upon matching the provider device 410f and the priority requester device 420, the airport priority matching system 104 reserves the provider devices 410d, 410f. Specifically, the airport priority matching system 104 analyzes the remaining pre-dispatch provider devices 410c, 410d, and 410f and reserves the pre-dispatch provider devices 410d, 410f based on comparing the time metrics.

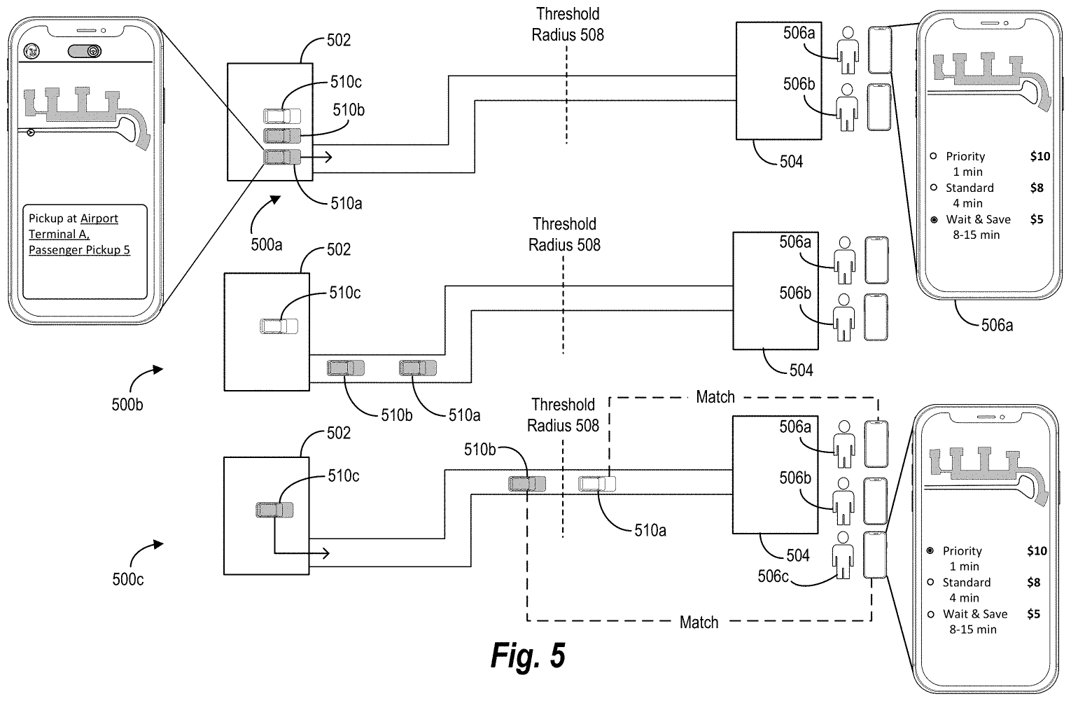

As mentioned above, in some embodiments, the airport priority matching system 104 also utilizes a priority queue of flex provider devices (or other onhold, dispatch provider devices) to respond to time priority airport transportation requests. For example, FIG. 5 illustrates identifying flexible time delay airport transportation requests, identifying preliminary matches with flex provider devices, and dispatching the flex provider devices while reserving the flex provider devices for priority requester devices.

For example, FIG. 5 illustrates a plurality of provider devices 510a-510c at a first time 500a. As shown, the airport priority matching system 104 also identifies a plurality of requester devices 506a-506b at an airport pickup location 504. The plurality of requester devices 506a-506b initiate flexible time delay airport transportation requests. Specifically, as shown with regard to the requester device 506a, the airport priority matching system 104 provides a graphical user interface that includes a standard transportation request option (with a first price and a first pickup time or wait time), a priority transportation request option (with a second price and a second pickup time or wait time), and a flexible time delay transportation request option (with a third price and a third pickup time or wait time, that includes a flexible time range).

In one or more embodiments, the airport priority matching system 104 utilizes the acts and algorithms described in UTILIZING PROVIDER DEVICE EFFICIENCY METRICS TO SELECT A PROVIDER DEVICE FOR A FUTURE TIME WINDOW, application Ser. No. 17/014,788, filed Sep. 8, 2020 (which is incorporated herein by reference herein in its entirety) to generate user interfaces, transportation requests, and transportation matches between flex provider devices and flex requester devices.

In response to receiving an indication of a selection of the flexible time delay transportation request option, the airport priority matching system 104 identifies a preliminary match with the provider device 510a at an airport staging lot 502. A preliminary match can include a variety of designations for aligning a pending transportation request with a provider device. In some embodiments, a preliminary match includes a designation within a database, matrix, or other digital medium that indicates an initial match between a requester device and a provider device (while remaining subject to change). In some implementations, a preliminary match includes dispatching a provider device in response to a transportation request (even if there is no formal match within a database, matrix, or other digital medium tying the provider device and requester device together). In other words, a preliminary match can include dispatching a provider device in response to a transportation while delaying a formal match or assignment for the provider device. Thus, a preliminary match indicates a provider devices in an onhold, dispatch state.

The airport priority matching system 104 can determine the preliminary match based on a variety of factors. For example, in some embodiments the airport priority matching system 104 determines preliminary matches based on a rank order of the provider devices 510a-510c within the airport provider device staging location. The airport priority matching system 104 can determine the preliminary matches based on time metrics, ranking orders, or a variety of other factors (e.g., historical provider device ratings, historical requester device ratings, selected destination of the transportation request, a preferred destination of the provider device, etc.).

In addition to the flexible time delay airport transportation request from the requester device 506a the airport priority matching system 104 also identifies a flexible time delay airport transportation request from the requester device 506b. In particular, the requester device 506b also selects flexible time delay airport transportation request option via a user interface. In addition, the airport priority matching system 104 identifies a preliminary match between the provider device 510b (i.e., a flex provider device) and the requester device 506b (i.e., a flex requester device).

Moreover, as shown, in response to receiving the flexible time delay airport transportation requests, the airport priority matching system 104 dispatches the flex provider devices 510a, 510b to the airport pickup location 504. Although the airport priority matching system 104 dispatches the flex provider devices 510a, 510b the airport priority matching system 104 reserves the flex provider devices 510a, 510b for potential time priority airport transportation requests.

In some embodiments, the airport priority matching system 104 dispatches the flex provider devices 510a, 510b but does not provide matching details to the flex provider devices 510a, 510b and/or the flex requester devices 506a, 506b. For example, as shown in FIG. 5, the airport priority matching system 104 provides a user interface to the flex provider device 510a including instructions for the flex provider device 510a to move to the airport pickup location. However, the airport priority matching system 104 does not provide a notification regarding the flex requester device 506a. Indeed, despite the preliminary match, the airport priority matching system 104 does not provide identifying information to either the flex requester device 506a or the flex provider device 510a. For example, the airport priority matching system 104 does not provide identifying information for the flex provider device 510a (e.g., car color, license plate number, driver picture, etc.) to the flex requester device 506a. Similarly, in some implementations, the airport priority matching system 104 does not provide identifying information for the flex requester device 506a (e.g., name, phone number, rider picture, etc.) to the flex provider device 510a. Indeed, in some embodiments, the airport priority matching system 104 does not provide any notification or indication to the flex requester device 506a regarding the preliminary match or the flex provider device 510a (e.g., the flex requester device 506a is unaware of the dispatch or preliminary match).

Although not implemented with regard to FIG. 5, in some embodiments the airport priority matching system 104 swaps transportation matches. For example, instead of a preliminary match, the airport priority matching system 104 generates a transportation match (provides notification regarding the transportation match to the provider device and requester device), and then generates a new transportation match upon receiving a priority transportation request.

As shown at the time 500b, the flex provider devices 510a, 510b travel toward the airport pickup location 504 based on preliminary matches with the requester provider devices 506a-506b while also being reserved to fulfill time priority airport transportation requests if they arise. As illustrated, the airport priority matching system 104 reserves the flex provider devices 510a, 510b while outside a threshold radius 508. Indeed, because the flex provider devices 510a, 510b are outside the threshold radius 508, the airport priority matching system 104 does not formally match the flex provider devices 510a, 510b to the flex requester devices 506a, 506b. Similarly, the airport priority matching system 104 does not distribute identifying information regarding the preliminary match to the flex provider devices 510a, 510b and/or the flex requester devices 506a, 506b.

As shown at the time 500c, however, the airport priority matching system 104 determines that the flex provider device 510a is within the threshold radius 508. In response, the airport priority matching system 104 releases the flex provider device 510a and finalizes a transportation match (e.g., by analyzing a pool of available provider devices). In some embodiments, the airport priority matching system 104 determines a match between the flex provider device 510a and the flex requester device 506a (e.g., assigns the flex provider device 510a to the flex requester device 506a or another requester device such a standard requester device). Moreover, the airport priority matching system 104 also provides additional match details to the flex provider device 510a and/or the flex requester device 506a. For example, the airport priority matching system 104 transmits identifying information (e.g., name, phone number, car color, images), estimated time of arrival, and other transportation match details to the flex provider device 510a and/or the flex requester device 506a.

In some embodiments, the airport priority matching system 104 searches for other transportation matches before matching the flex provider device 510a and the flex requester device 506a. For example, if there are no priority requester devices, the airport priority matching system 104 analyzes standard requester devices to determine a transportation match. If a standard requester device has initiated a standard airport transportation request, the airport priority matching system 104 generates a match between the requester device 506a and the standard requester device. Thus, the airport priority matching system 104 can analyze a ranked hierarchy of transportation requests in finalizing a transportation match (e.g., look first to priority requester devices, then standard requester devices, then flex requester devices).

Moreover, as illustrated at the time 500c, the airport priority matching system 104 also receives an additional transportation request from a requester device 506c. In particular, the requester device 506c selects a time priority airport transportation request option within a user interface. In response, the airport priority matching system 104 generates a priority transportation match. Specifically, the airport priority matching system 104 analyzes available provider devices and matches the priority requester device 506c to the provider device 510b. Indeed, the airport priority matching system 104 determines that the provider device 510b is reserved for time priority airport transportation services (and has the shortest time metric of available provider devices) and assigns the provider device 510b to the priority requester device 506c.

In generating the priority transportation match, the airport priority matching system 104 also drops the preliminary match between the provider device 510b and the requester device 506b. Indeed, the airport priority matching system 104 no longer has any anticipated provider device for the flex requester device 506b. Accordingly, the airport priority matching system 104 determines an additional preliminary match for the flex requester device 506b. Specifically, utilizing the process described above determining preliminary matches, the airport priority matching system 104 generates a preliminary match between the provider device 510c and the flex requester device 506b. Moreover, the airport priority matching system 104 dispatches the flex provider device 510c to the airport pickup location 504.

In this manner, the airport priority matching system 104 can iteratively generate preliminary matches for flex requester devices and dispatch corresponding flex provider devices, while reserving the flex provider devices for time priority airport transportation services. Although not illustrated, in one or more embodiments, the airport priority matching system 104 monitors an expiration time corresponding to the flexible time delay airport transportation request and dynamically reserves or releases flex provider devices based on the expiration time. Indeed, as illustrated in FIG. 5, the flex requester device 506a corresponds to an expiration time (e.g., 15 minutes after the transportation request was initiated).

For example, as the current time approaches the expiration time, the airport priority matching system 104 will release a flex provider device with a preliminary match to a flex provider device. To illustrate, in some embodiments, the airport priority matching system 104 identifies a cutoff time (e.g., a threshold time prior to the expiration time). If the current time is past the cutoff time, the airport priority matching system 104 will release a flex provider devices and assign the flex provider device to the requester device (e.g., to ensure that the flex requester device obtains transportation prior to the expiration time).

The airport priority matching system 104 can determine the cutoff time utilizing a variety of approaches. For example, in some embodiments, the airport priority matching system 104 determines the cutoff time based on an estimated travel time and the expiration time. To illustrate, the airport priority matching system 104 sets the cutoff time to be earlier than the difference between the expiration time and the estimated travel time.

In some embodiments, the airport priority matching system 104 utilizes a remaining time measure (e.g., the difference between the current time and the expiration time) as a weight to determine when to release a flex provider device. For example, the airport priority matching system 104 can consider a variety of factors in determining when to release a flex provider devices and assign the flex provider device to a flex requester device (e.g., total value of a priority requester device, estimated number of priority requester devices in the remaining time, number of reserved provider devices, etc.). The airport priority matching system 104 can balance these factors together with the remaining time to determine when to release a flex provider device and finalize a match between the flex provider device and the flex requester device.

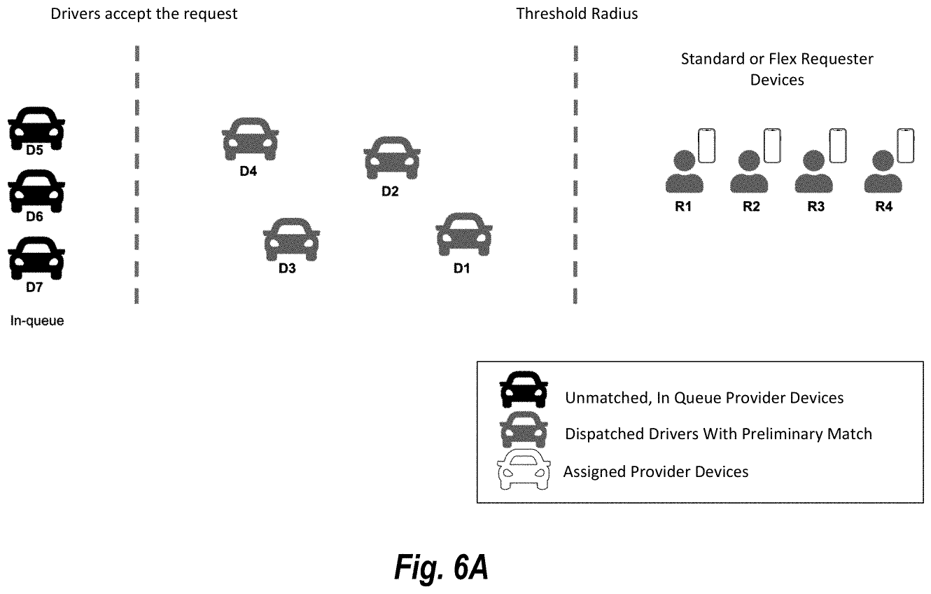

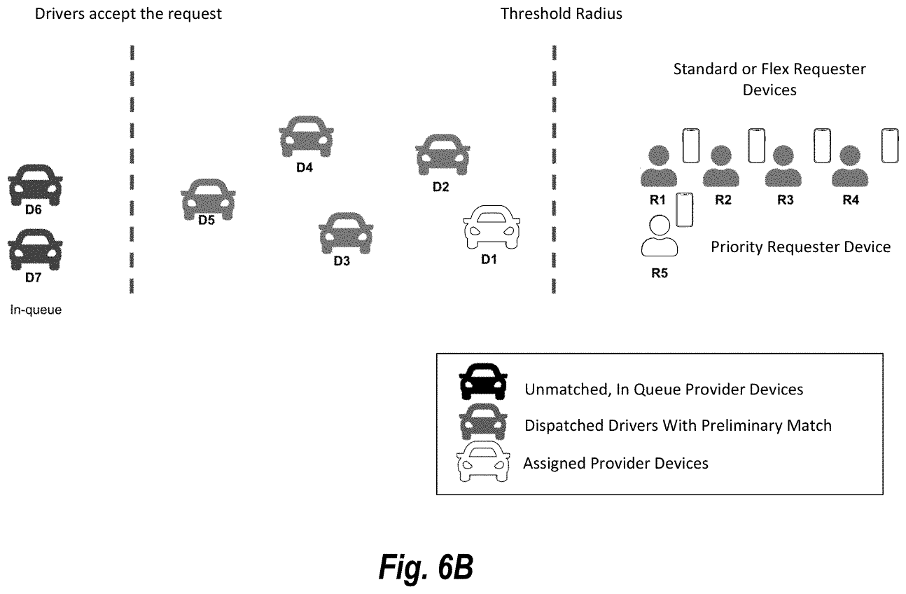

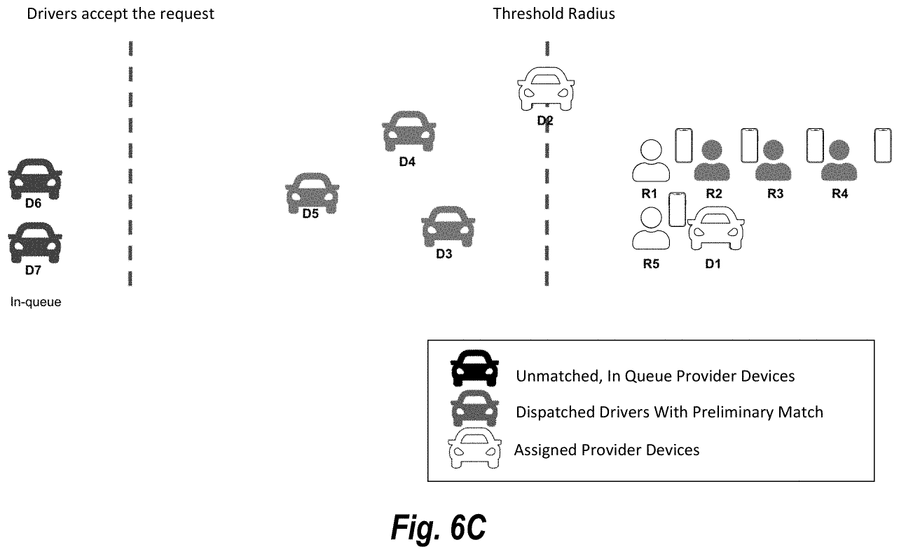

Although FIG. 5 describes preliminary matching with respect to flex requester devices and flex provider devices, the airport priority matching system 104 can also implement a priority queue of preliminary matches for standard transportation requests and/or flexible time delay transportation requests. For example, FIGS. 6A-6C illustrate a priority queue of preliminary match provider devices (e.g., matched with standard transportation requests and/or flexible time delay transportation requests).

For example, FIG. 6A illustrates a first set of provider devices (D5-D7) that are unmatched (e.g., in a queue at a staging lot). Moreover, FIG. 6A illustrates a second set of provider devices (D1-D4) with a preliminary match to a set of requester devices (R1-R4). The requester devices can initiate standard transportation requests and/or flexible time delay transportation requests. As shown, the provider devices D1-D4 accept a request for a preliminary match and travel toward an airport pickup location. For example, the airport priority matching system 104 determines preliminary matches as follows: D1-R1, D2-R2, D3-R3, and D4-R4. Moreover, the airport priority matching system 104 reserves the provider devices D1-D4 for time priority airport transportation services.

As shown in FIG. 6B, a new requester device R5 initiates a time priority airport transportation request. In response, the airport priority matching system 104 assigns the available provider device with the lowest time metric to the priority requester device. Thus, the airport priority matching system 104 determines a transportation match between the priority requester device R5 and the provider device D1.

Because the airport priority matching system 104 assigns the provider device D1 to the priority requester device R5, in some embodiments, the airport priority matching system 104 determines new preliminary matches (e.g., drops the preliminary match for the provider device D1 and determines new preliminary matches for other provider devices). For example, the airport priority matching system 104 determines the following preliminary matches between the remaining provider devices and the requester devices: D2-R1, D3-R2, D4-R3, D5-R4.

As shown in FIG. 6C, another requester device D2 reaches the threshold radius. In response, the airport priority matching system 104 assigns the provider device D2 to the requester device R1. Indeed, the airport priority matching system 104 finalizes the preliminary match (D2-R1) and assigns the provider device D2 to the requester device R1 (e.g., the first requester device to submit a transportation request).

Although FIGS. 6A-6C illustrate a single combined priority queue for standard or flexible transportation requests, in some embodiments, the airport priority matching system 104 utilizes separate priority queues for standard and flexible transportation requests. For example, in some embodiments, the airport priority matching system 104 first reserves flex provider devices for time priority airport transportation requests and (if additional reservations are needed) reserves standard provider devices (i.e., provider devices with a preliminary match to a standard request). Accordingly, the airport priority matching system 104 can utilize the approach illustrated in FIGS. 6A-6C first for flex provider devices and then for standard provider devices. In some embodiments, the airport priority matching system 104 utilizes the approach illustrated in FIGS. 6A-6C to reserve only flex provider devices.

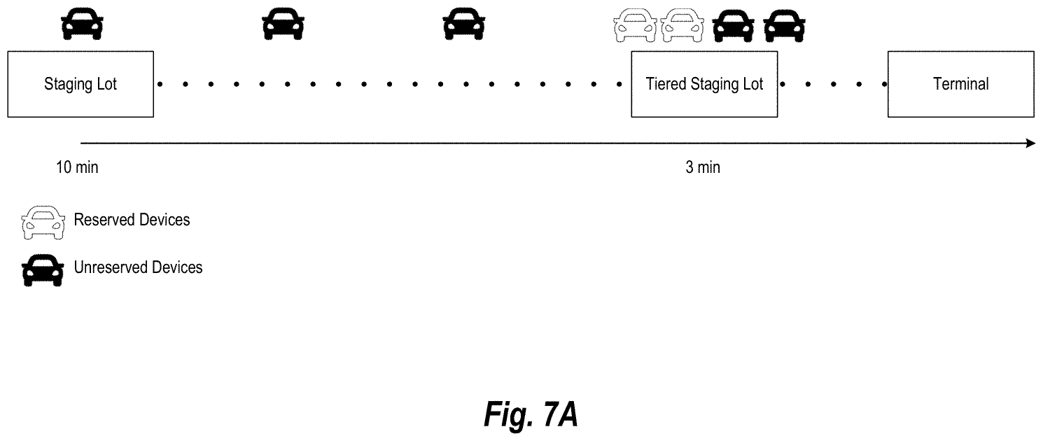

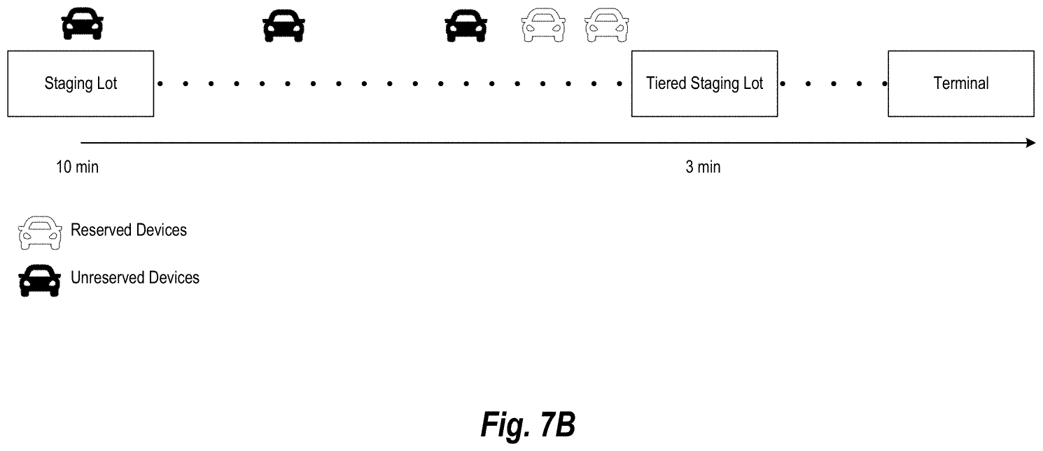

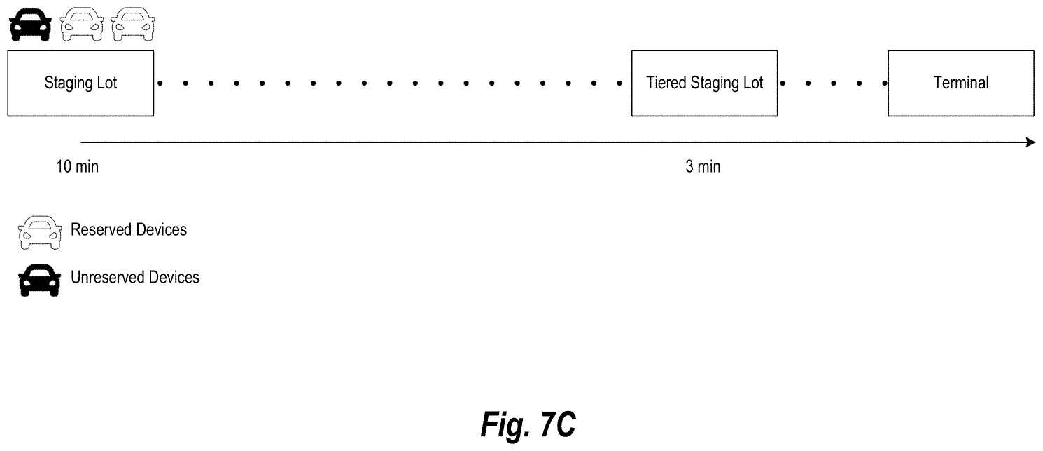

As mentioned previously, in one or more embodiments, the airport priority matching system 104 dynamically reserves different provider devices (e.g., from different categories, types, or stages) depending on the characteristics at any particular time. For example, FIGS. 7A-7C illustrate the airport priority matching system 104 reserving different provider devices within the same airport configuration depending on different device imbalances between requester devices and provider devices. Specifically, FIGS. 7A-7C illustrate an airport that includes an initial airport provider device staging location and that includes an airport provider device tiered staging location.

In particular, FIG. 7A illustrates the airport configuration with a device imbalance weighted toward provider devices (e.g., excess provider devices relative to requester devices). As shown, the airport provider device tiered staging location has a high number of provider devices, additional provider devices are traveling to the airport provider device tiered staging location, and the initial airport provider device staging location also has one or more provider devices.

The airport priority matching system 104 determines a number of provider devices to reserve. In this example, the airport priority matching system 104 determines that two provider devices are needed. Moreover, the airport priority matching system 104 analyzes the provider devices to reserve the determined number. With regard to FIG. 7A, the airport priority matching system 104 has a priority order for types/categories/stages if provider devices as follows: (1) provider devices at the airport provider device tiered staging location, (2) provider devices traveling to the airport provider device tiered staging location, and (3) provider devices at the initial airport provider device staging location. Moreover, the airport priority matching system 104 has a threshold limit of reserving two provider devices (e.g., 50% of the available provider devices) from at the airport provider device tiered staging location.

Accordingly, as shown, the airport priority matching system 104 reserves provider devices from the airport provider device tiered staging location until reaching the threshold limit (i.e., 2). As discussed above, the airport priority matching system 104 reserves the two provider devices in inverse order of arrival. Moreover, because these provider devices satisfy the total number of provider devices to reserve the airport priority matching system 104 does not reserve additional provider devices. The remainder of the provider devices are thus available for matching for other transportation requests (e.g., standard transportation requests).

FIG. 7B illustrates the airport configuration with fewer provider devices (e.g., a more mixed balance between provider devices and requester devices). As shown, there are no devices available at the airport provider device tiered staging location. Accordingly, to satisfy the needed number of provider devices (i.e., 2), the airport priority matching system 104 looks to provider devices traveling to the airport provider device tiered staging location. In particular, the airport priority matching system 104 selects two provider devices traveling to the airport provider device tiered staging location by comparing travel metrics for the provider (e.g., by selecting the two lowest ETAs or travel times relative to the airport pickup location).

FIG. 7C illustrates the airport configuration with a device imbalance weighted toward requested devices (e.g., excess requester devices relative to provider devices). As shown, there are no provider devices available at the airport provider device tiered staging location. Moreover, there are no provider devices en route to the airport provider device tiered staging location. Accordingly, the airport priority matching system 104 reserves two provider devices from the initial airport provider device staging location. In particular, the airport priority matching system 104 reserves two provider devices based on inverse order of arrival at the initial airport provider device staging location. Thus, as the balance of provider devices and requester devices changes over time, the airport priority matching system 104 flexibly adapts to reserve provider devices from different stages/categories/types.

As mentioned above, in one or more embodiments, the airport priority matching system 104 utilizes one or more prediction models to determine estimations and/or hyperparameters for reserving and matching provider devices for time priority airport transportation services. For example, FIG. 8 illustrates the airport priority matching system 104 determining hyperparameters in accordance with one or more embodiments.

In particular, FIG. 8 illustrates the airport priority matching system 104 utilizing a requester device prediction model 806 to determine predicted requester devices 808 from historical features 802 corresponding to an airport. For example, the airport priority matching system 104 can identify historical features reflecting the number, type, and outcome of transportation requests (e.g., within the airport boundary region). Although not illustrated, in some embodiments the airport priority matching system 104 can also identify current features, such as the number of current requests, the current number of requester devices, airport arrival and departure schedules, or other signals that impact requester devices at an airport.

As illustrated, the airport priority matching system 104 analyzes these features utilizing the requester device prediction model 806 to generate predicted requester devices 808. In particular, the predicted requester devices 808 can include an estimation of the number of requester devices at one or more times. Moreover, the predicted requester devices 808 can include an estimation of the number of priority requester devices, standard requester devices, and/or flex requester devices.

As mentioned above, the airport priority matching system 104 can utilize a variety of models to generate the predicted requester devices 808. For example, in one or more embodiments, the airport priority matching system 104 utilizes a machine learning model (such as a neural network) to generate the predicted requester devices 808. In some embodiments, the airport priority matching system 104 utilizes a statistical or heuristic model to generate the predicted requester devices 808.

As shown, the airport priority matching system 104 utilizes the predicted requester devices 808 together with current device features 812 and airport features 814 to determine hyperparameters 816 via a hyperparameter model 810. For example, the airport priority matching system 104 identifies current device features (e.g., reflecting the current supply condition). For example, in one or more embodiments, the airport priority matching system 104 determines a number of open transportation requests, a number of available provider devices en route (e.g., en route to a tiered staging lot and/or en route to an airport pickup location), a number of provider devices at a staging lot, a tiered staging lot and/or an airport pickup location), a number of pending pre-dispatch drivers, a number of provider devices in a queue, and/or a number of assigned provider devices or provider devices with a preliminary match (and their ETA).

Moreover, with regard to airport features 814, the airport priority matching system 104 can determine physical configurations (e.g., available staging lots, positions of airport pickup locations) and/or regulations (e.g., rules or constraints for the particular airport). For example, the airport priority matching system 104 can determine that a particular airport does not permit pre-dispatch provider devices, does not permit waiting at particular locations (or past a certain threshold time), etc.

As shown, the airport priority matching system 104 utilizes the hyperparameter model 810 to generate hyperparameters from these input signals. As mentioned above, the airport priority matching system 104 can utilize a variety of computer-implemented models for the hyperparameter model 810. In some embodiments, the airport priority matching system 104 utilizes a machine learning model, such as a neural network or decision-tree to predict hyperparameters based on these input signals. The airport priority matching system 104 can train such a machine learning model based on historical input signals (and ground truth hyperparameters or reward functions) to generate hyperparameters.

In some embodiments, the airport priority matching system 104 utilizes a simulation model for the hyperparameter model 810. In particular, the airport priority matching system 104 can utilize a simulation model that simulates provider devices and requester devices within an airport (as defined by the airport features 814) according to the predicted requester devices 808 and the current device features 812 and according to various input hyperparameters to model how each hyperparameter will impact significant variables. For example, as shown in FIG. 8, the airport priority matching system 104 can model a priority time metric. To illustrate, the airport priority matching system 104 can model a change or measure of response time, ETA time, or travel time for provider devices to respond to priority requester devices based on the various hyperparameters. Indeed, the airport priority matching system 104 can simulate requests, reserving provider devices, priority requests, travel times, pickups, etc. and measure the priority time metric for priority requester devices and time priority airport transportation requests.

The airport priority matching system 104 can also model other time metrics. For example, as shown the airport priority matching system 104 can simulate a change or measure of waiting time, ETA time, or travel time for standard requester devices and standard transportation requests. Similarly, the airport priority matching system 104 can determine provider device time metrics (e.g., waiting time, travel time, ETA for different provider devices). In addition, the airport priority matching system 104 can simulate compliance with various airport constraining parameters (e.g., allowed waiting times or other rules determining permitted activities).

In one or more embodiments, the airport priority matching system 104 selects hyperparameters by running various simulations and selecting hyperparameters that improve priority time metrics while preserving standard time metrics, provider device time metrics, and airport constraining parameters.

In one or more embodiments, the airport priority matching system 104 utilizes an objective function for the hyperparameter model 810. For example, the airport priority matching system 104 can select hyperparameters to improve an objective for response time (e.g., ETA time, travel time, wait time) for time priority airport transportation requests subject to various constraints or counter-objectives. For example, in one or more embodiments, the airport priority matching system 104 seeks to improve an objective that reduces wait time for priority requester devices subject to constraints on standard time metrics (e.g., a threshold increase in standard requester device wait times), provider device time metrics (e.g., a threshold increase in provider device wait time, travel time, or ETA), and airport constraining parameters. Thus, the airport priority matching system 104 can optimize the hyperparameters to reduce waiting time (or ETA) of priority requester devices while preserving the experience of other drivers and riders (short and long-term)

As illustrated, utilizing the hyperparameter model 810, the airport priority matching system 104 can determine one or more of the hyperparameters 816. For example, the hyperparameters 816 can include a number of provider devices to reserve, a number of provider devices to pre-dispatch, a number of provider devices to send to tiered staging locations, a threshold radius, and/or a threshold reservation time.

To illustrate, in one or more embodiments the airport priority matching system 104 utilizes the hyperparameter model 810 to determine a number of provider devices to reserve. For example, in one or more embodiments, the airport priority matching system 104 determines a number of anticipated priority requester devices and a number of provider devices. The airport priority matching system 104 determines the number of provider devices to reserve based on the anticipated priority requester devices and the number of provider devices. To illustrate, the airport priority matching system 104 reserves a number equal to or greater than the anticipated priority requester devices subject to a condition based on the number of provider devices (e.g., less than a total number of provider devices or some other threshold number of provider devices).

Moreover, in some implementations, the airport priority matching system 104 determines a number of provider devices to reserve from a particular category/type/state of provider devices. To illustrate, the airport priority matching system 104 can determine a number of provider devices to reserve from an airport provider device tiered staging lot, from pre-dispatch provider devices, from unavailable provider devices, from flex provider devices, or provider devices with a preliminary match (e.g., provider devices in an onhold, dispatch state). For instance, the airport priority matching system 104 can determine a number of provider devices to reserve from an airport provider device tiered staging location based on the anticipated priority requester devices, the capacity at an airport provider device tiered staging location, and/or the total number of provider devices dispatched to the airport provider device tiered staging location. To illustrate, the airport priority matching system 104 determines the number of provider devices to reserve at an airport provider device tiered staging location utilizing the following formulation:

min{Q, N}=>n>D

where D is the forecast number of priority provider devices over the next period of time (e.g., updated every 15-min, every day of week, for each tiered staging location), N is the total number of provider devices available, n is the total number of reserved provider drivers, and Q is the maximum capacity of the tiered staging location. This formulation results in reserving more provider devices than expected requester devices so long as the airport priority matching system 104 does not exceed capacity of the tiered staging location.

In some embodiments, the airport priority matching system 104 determines the number of provider devices to reserve from an airport provider device tiered staging location as a function of the number of provider devices dispatched to the airport provider device tiered staging location. For example, in one or more embodiments, the airport priority matching system 104 reserves a certain percentage (e.g., 25%) of provider devices at an airport provider device tiered staging location.

The airport priority matching system 104 can utilize a similar analysis with regard to other categories/types/states of provider devices. For example, the airport priority matching system 104 can determine a number of pre-dispatch provider devices to reserve based on a number of pre-dispatch providers and anticipated priority requester devices. Moreover, the airport priority matching system 104 can determine a number of pre-dispatch provider devices to reserve as a percentage of the pre-dispatch provider devices. Similarly, the airport priority matching system 104 can reserve a number of flex provider devices, unavailable provider devices, based on anticipated number of priority requester devices and a number of provider devices in each category/type/status.

As mentioned above, in some embodiments the airport priority matching system 104 utilizes a machine learning model, simulator model, and/or objective function to select the number of provider devices to reserve. Thus, the airport priority matching system 104 can select the number of provider devices to utilizing these approaches. For example, the airport priority matching system 104 can utilize a machine learning model to generate a predicted number of provider devices to reserve. Similarly, the airport priority matching system 104 can run simulations with different numbers of provider devices and select the number based on simulation results (e.g., that will reduce waiting time for priority provider devices). Moreover, the airport priority matching system 104 can utilize an objective function that selects the number of provider devices to reserve that reduces wait time for priority requester devices subject to constraints on standard time metrics (e.g., a threshold increase in standard requester device wait times), provider device time metrics (e.g., a threshold increase in provider device wait time, travel time, or ETA), and airport constraining parameters.

As mentioned above, the airport priority matching system 104 can also utilize the hyperparameter model 810 to determine a number of provider devices to pre-dispatch. The airport priority matching system 104 can utilize a variety of models to determine the number of provider devices to pre-dispatch. For example, in some embodiments, the airport priority matching system 104 utilizes a machine learning model that analyzes anticipated requester devices to select a number of pre-dispatch provider devices. In some embodiments, the airport priority matching system 104 utilizes a heuristic model or objective function. To illustrate, in one or more embodiments, the airport priority matching system 104 utilizes the acts and algorithms described in UTILIZING A REQUESTOR DEVICE FORECASTING MODEL WITH FORWARD AND BACKWARD LOOKING QUEUE FILTERS TO PRE-DISPATCH PROVIDER DEVICES, application Ser. No. 16/827,3045, filed Mar. 23, 2020 (which is incorporated herein by reference in its entirety).

Similarly, the airport priority matching system 104 can determine a number of provider devices to send to tiered staging locations, a threshold radius, and/or a threshold reservation time. Indeed, the airport priority matching system 104 can utilize machine learning models trained based on historical data to generate these hyperparameters. Moreover, in some embodiments, the airport priority matching system 104 utilizes simulation models to simulate performance across different numbers of provider devices, different threshold radii, and different threshold reservation times to select these hyperparameters. In addition, in some implementations, the airport priority matching system 104 utilizes an objective function to select hyperparameters that will improve wait times for priority requester devices subject to constraints with regard to the impact on standard requester devices, provider devices, and airport constraining parameters.

As mentioned above, the airport priority matching system 104 can also dynamically adapt to different airport configurations. For example, different airports have different physical configurations and some airports have different regulations. Thus, some airports may not have an airport provider device tiered staging location, some airports may not allow pre-dispatch provider devices, and some airports may not include an initial airport provider device tiered staging location. The airport priority matching system 104 can identify airport features or characteristics and dynamically modify its processes to accommodate the various configurations for individual airports.

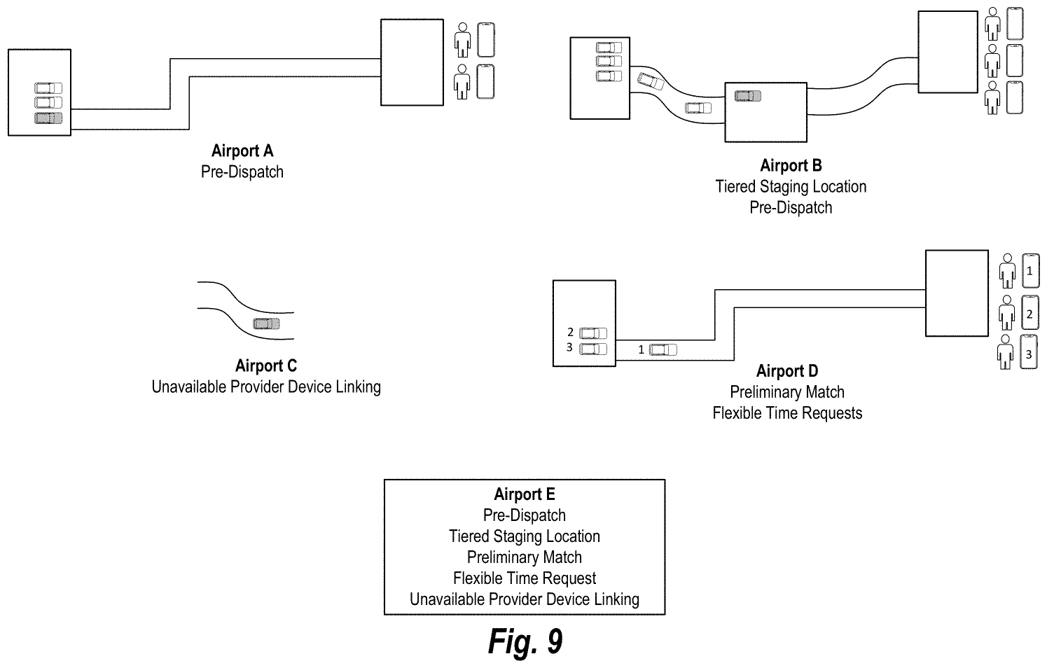

For example, as shown in FIG. 9, the airport priority matching system 104 determines that Airport A does not include airport provider device tiered staging location. In response, the airport priority matching system 104 utilizes pre-dispatch provider devices to respond to time priority airport transportation requests. Similarly, the airport priority matching system 104 determines that Airport B includes a tiered staging location. In response, the airport priority matching system 104 utilizes pre-dispatch provider devices and the tiered staging location to respond to time priority airport transportation requests.

The airport priority matching system 104 determines that Airport C does not have any staging locations, does not allow pre-dispatch, and does not allow preliminary matching. Accordingly, at airport C, the airport priority matching system 104 utilizes unavailable provider devices to respond to time priority airport transportation requests. In contrast, the airport priority matching system 104 determines that Airport D does not include a tiered staging location and prohibits pre-dispatch provider devices. In response, the airport priority matching system 104 utilizes flex provider devices (and flexible time delay time requests) and other provider devices with a preliminary match to respond to time priority airport transportation requests. Moreover, the airport priority matching system 104 determines that Airport E does not include any restrictions and has a variety of different staging lots, so utilizes any approach described herein to respond to time priority airport transportation requests.

Although FIG. 9 illustrates a particular configuration of certain combinations at particular airports, the airport priority matching system 104 can utilize a variety of different approaches as described herein based on the configurations of different airports.

In one or more embodiments, each of the components of the airport priority matching system 104 are in communication with one another using any suitable communication technologies. Additionally, the components of the airport priority matching system 104 can be in communication with one or more other devices including one or more client devices described above. Furthermore, although the components of FIG. 9 are described in connection with the airport priority matching system 104, at least some of the components for performing operations in conjunction with the airport priority matching system 104 described herein may be implemented on other devices within the environment.

The components of the airport priority matching system 104 can include software, hardware, or both. For example, the components of the airport priority matching system 104 can include one or more instructions stored on a computer-readable storage medium and executable by processors of one or more computing devices. When executed by the one or more processors, the computer-executable instructions of the airport priority matching system 104 can cause the computing device to perform the methods described herein. Alternatively, the components of the airport priority matching system 104 can comprise hardware, such as a special purpose processing device to perform a certain function or group of functions. Additionally or alternatively, the components of the airport priority matching system 104 can include a combination of computer-executable instructions and hardware.

Furthermore, the components of the airport priority matching system 104 performing the functions described herein may, for example, be implemented as part of a stand-alone application, as a module of an application, as a plug-in for applications including content management applications, as a library function or functions that may be called by other applications, and/or as a cloud-computing model. Thus, the components of the airport priority matching system 104 may be implemented as part of a stand-alone application on a personal computing device or a mobile device. Alternatively or additionally, the components of the airport priority matching system 104 may be implemented in any application that allows creation and delivery of marketing content to users, including, but not limited to, various applications.

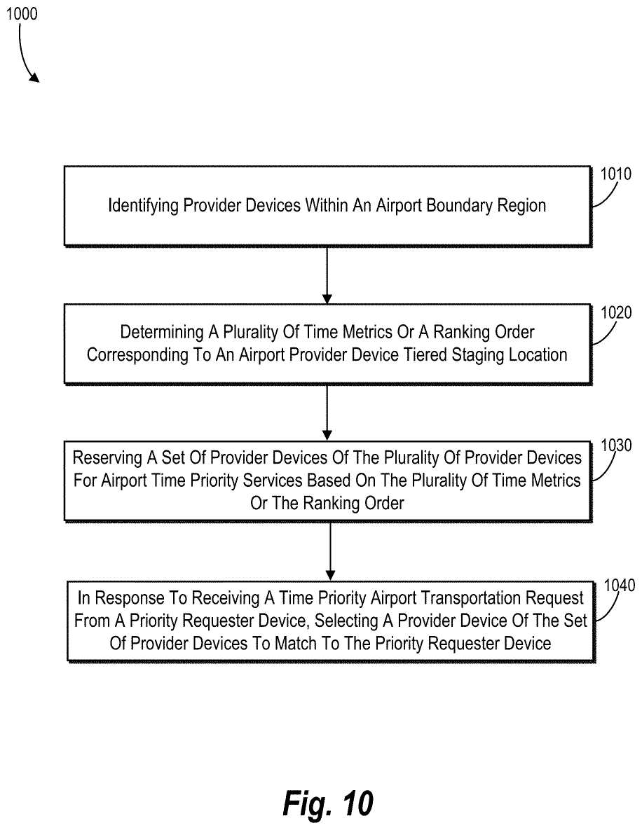

FIGS. 1-9, the corresponding text, and the examples provide a number of different systems, methods, and non-transitory computer readable media for selecting and providing a transportation request to a limited-eligibility provider device. In addition to the foregoing, embodiments can also be described in terms of flowcharts comprising acts for accomplishing a particular result. For example, FIG. 10 illustrates a flowchart of an example sequence of acts in accordance with one or more embodiments.

While FIG. 10 illustrates acts according to some embodiments, alternative embodiments may omit, add to, reorder, and/or modify any of the acts shown in FIG. 10. The acts of FIG. 10 can be performed as part of a method. Alternatively, a non-transitory computer readable medium can comprise instructions, that when executed by one or more processors, cause a computing device to perform the acts of FIG. 10. In still further embodiments, a system can perform the acts of FIG. 10. Additionally, the acts described herein may be repeated or performed in parallel with one another or in parallel with different instances of the same or other similar acts.

FIG. 10 illustrates an example series of acts 1000 for matching provider devices to time priority airport transportation requests in accordance with one or more embodiments. As shown, the series of acts 1000 includes an act 1010 of identifying provider devices within an airport boundary region, an act 1020 of determining a plurality of time metrics or a ranking order corresponding to an airport provider device tiered staging location, an act 1030 of reserving a set of provider devices of the plurality of provider devices for airport time priority services based on the plurality of time metrics or the ranking order, and an act 1040 of in response to receiving a time priority airport transportation request from a priority requester device, selecting a provider device of the set of provider devices to match to the priority requester device.

For example, in one or more implementations the acts 1010-1040 include: identifying, utilizing global positioning data, a plurality of provider devices within an airport boundary region; determining, for the plurality of provider devices based on the global positioning data, a plurality of time metrics relative to an airport pickup location or a ranking order corresponding to an airport provider device tiered staging location; prior to receiving a time priority airport transportation request, reserving a set of provider devices of the plurality of provider devices for airport time priority services based on the plurality of time metrics relative to the airport pickup location or the ranking order; and in response to receiving the time priority airport transportation request from a priority requester device, selecting a provider device from a pool of available provider devices comprising the set of provider devices to match to the priority requester device.

In one or more implementations, the series of acts 1000 also includes identifying, utilizing the global positioning data, a first subset of the plurality of provider devices at an initial provider device staging location and a second subset of the plurality of provider devices at the airport provider device tiered staging location; and determining the ranking order corresponding to the airport provider device tiered staging location based on an arrival order of the second subset of the plurality of provider devices at the airport provider device tiered staging location.

Furthermore, in some implementations, the series of acts 1000 includes reserving the set of provider devices from the second subset of the plurality of provider devices based on an inverse order of the arrival order of the second subset of the plurality of provider devices.

In one or more implementations, the series of acts 1000 includes in response to identifying a new provider device at the airport provider device tiered staging location, reserving the new provider device and releasing a provider device of the set of provider devices based on the ranking order.

Moreover, in some implementations, the series of acts 1000 includes determining a reserved time for a provider device of the set of provider devices; and in response to determining that the reserved time exceeds a threshold reservation time, releasing the provider device from being reserved for the airport time priority services.

In addition, in some implementations, the series of acts 1000 includes identifying a plurality of pre-dispatch provider devices dispatched to the airport pickup location; determining time metrics relative to the airport pickup location for the plurality of pre-dispatch provider devices; and reserving the set of provider devices from the plurality of pre-dispatch provider devices based on the time metrics for the plurality of pre-dispatch provider devices.

In one or more implementations, the series of acts 1000 includes in response to determining, based on the global positioning data, that a pre-dispatch provider device of the set of provider devices is located within a threshold radius of the airport pickup location, releasing the pre-dispatch provider device from being reserved for the airport time priority services.

Furthermore, in some implementations, the series of acts 1000 includes in response to receiving a flexible time delay airport transportation request from a flex requester device at the airport pickup location, dispatching a flex provider device to the airport pickup location; and reserving the flex provider device for the airport time priority services based on a time metric of the flex provider device relative to the airport pickup location.

In one or more implementations, the series of acts 1000 includes in response to receiving the time priority airport transportation request and determining that the flex provider device is outside a threshold radius relative to the airport pickup location, selecting the flex provider device as the provider device to match to the priority requester device.

In one or more implementations, the series of acts 1000 includes in response to determining that the flex provider device is within a threshold radius relative to the airport pickup location, releasing the flex provider device and matching the flex provider device to the flex requester device.

In one or more implementations, the series of acts 1000 includes in response to identifying preliminary matches between the plurality of provider devices and a plurality of requester devices at the airport pickup location, dispatching the plurality of provider devices to the airport pickup location; and reserving the set of provider devices from the plurality of provider devices based on the plurality of time metrics relative to the airport pickup location.

In one or more implementations, the series of acts 1000 includes in response to determining that a first provider device of the set of provider devices having a first preliminary match with a first requester device is located within a threshold radius of the airport pickup location, releasing the first provider device from being reserved for the airport time priority services and matching the first provider device to the first requester device according to the first preliminary match.

In one or more implementations, the series of acts 1000 includes determining a second preliminary match between the provider device and a second requester device; and in response to receiving the time priority airport transportation request from the priority requester device, matching the provider device to the priority requester device and dropping the second preliminary match between the provider device and the second requester device.

In one or more implementations, the series of acts 1000 includes identifying a plurality of unavailable provider devices transporting requester devices to the airport boundary region; determining time metrics relative to the airport pickup location for the plurality of unavailable provider devices; and reserving the set of provider devices from the plurality of unavailable provider devices based on the time metrics relative to the airport pickup location.

In one or more implementations, the series of acts 1000 includes determining a number of provider devices to reserve in the set of provider devices by utilizing a prediction model to determine at least one of an estimated number of requester devices at the airport pickup location or an estimated number of provider devices to dispatch to the airport provider device tiered staging location.

In one or more implementations, the series of acts 1000 includes determining the threshold reservation time by utilizing a prediction model to determine an estimated number of requester devices at the airport pickup location.

In one or more implementations, the series of acts 1000 includes reserving the set of provider devices until detecting that one or more provider devices of the set of provider devices is within a threshold radius of the airport pickup location.

In one or more implementations, the series of acts 1000 includes determining the threshold radius by utilizing a prediction model to determine an estimated number of requester devices at the airport pickup location.

In one or more implementations, the series of acts 1000 includes utilizing a hyperparameter model to select one or more hyperparameters comprising at least one of: a number of provider devices to reserve, a threshold reservation radius, or a threshold reservation time.

In one or more implementations, the hyperparameter model comprises at least one of a simulator model, a machine learning model, or an objective function.

In one or more implementations, the hyperparameter model comprises the objective function and the series of acts 1000 includes selecting the one or more hyperparameters by reducing estimated time of arrival for time priority requests subject to constraints on requester device wait times, provider device wait times, and airport constraining parameters.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 11 illustrates, in block diagram form, an exemplary computing device 1100 (e.g., the provider devices 108a-108n, the requester device 112, or the server(s) 106) that may be configured to perform one or more of the processes described above. One will appreciate that the airport priority matching system 104 can comprise implementations of the computing device 1100, including, but not limited to, the provider devices 108a-108n and/or the server(s) 106. As shown by FIG. 11, the computing device can comprise a processor 1102, memory 1104, a storage device 1106, an I/O interface 1108, and a communication interface 1110. In certain embodiments, the computing device 1100 can include fewer or more components than those shown in FIG. 11. Components of computing device 1100 shown in FIG. 11 will now be described in additional detail.

In particular embodiments, processor(s) 1102 includes hardware for executing instructions, such as those making up a computer program. As an example, and not by way of limitation, to execute instructions, processor(s) 1102 may retrieve (or fetch) the instructions from an internal register, an internal cache, memory 1104, or a storage device 1106 and decode and execute them.

The computing device 1100 includes memory 1104, which is coupled to the processor(s) 1102. The memory 1104 may be used for storing data, metadata, and programs for execution by the processor(s). The memory 1104 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 1104 may be internal or distributed memory.

The computing device 1100 includes a storage device 1106 includes storage for storing data or instructions. As an example, and not by way of limitation, storage device 1106 can comprise a non-transitory storage medium described above. The storage device 1106 may include a hard disk drive (“HDD”), flash memory, a Universal Serial Bus (“USB”) drive or a combination of these or other storage devices.

The computing device 1100 also includes one or more input or output interface 1108 (or “I/O interface 1108”), which are provided to allow a user (e.g., requester or provider) to provide input to (such as user strokes), receive output from, and otherwise transfer data to and from the computing device 1100. These I/O interface 1108 may include a mouse, keypad or a keyboard, a touch screen, camera, optical scanner, network interface, modem, other known I/O devices or a combination of such I/O interface 1108. The touch screen may be activated with a stylus or a finger.

The I/O interface 1108 may include one or more devices for presenting output to a user, including, but not limited to, a graphics engine, a display (e.g., a display screen), one or more output providers (e.g., display providers), one or more audio speakers, and one or more audio providers. In certain embodiments, interface 1108 is configured to provide graphical data to a display for presentation to a user. The graphical data may be representative of one or more graphical user interfaces and/or any other graphical content as may serve a particular implementation.

The computing device 1100 can further include a communication interface 1110. The communication interface 1110 can include hardware, software, or both. The communication interface 1110 can provide one or more interfaces for communication (such as, for example, packet-based communication) between the computing device and one or more other computing devices 1100 or one or more networks. As an example, and not by way of limitation, communication interface 1110 may include a network interface controller (“NIC”) or network adapter for communicating with an Ethernet or other wire-based network or a wireless NIC (“WNIC”) or wireless adapter for communicating with a wireless network, such as a WI-FI. The computing device 1100 can further include a bus 1112. The bus 1112 can comprise hardware, software, or both that connects components of computing device 1100 to each other.

FIG. 12 illustrates an example network environment 1200 of the transportation matching system 102. The network environment 1200 includes a client device 1206 (e.g., the provider devices 108a-108n or the requester device 112), a transportation matching system 102, and a vehicle subsystem 1208 connected to each other by a network 1204. Although FIG. 12 illustrates a particular arrangement of the client device 1206, the transportation matching system 102, the vehicle subsystem 1208, and the network 1204, this disclosure contemplates any suitable arrangement of client device 1206, the transportation matching system 102, the vehicle subsystem 1208, and the network 1204. As an example, and not by way of limitation, two or more of client device 1206, the transportation matching system 102, and the vehicle subsystem 1208 communicate directly, bypassing network 1204. As another example, two or more of client device 1206, the transportation matching system 102, and the vehicle subsystem 1208 may be physically or logically co-located with each other in whole or in part.

Moreover, although FIG. 12 illustrates a particular number of client devices 1206, transportation matching systems 102, vehicle subsystems 1208, and networks 1204, this disclosure contemplates any suitable number of client devices 1206, transportation matching system 102, vehicle subsystems 1208, and networks 1204. As an example, and not by way of limitation, network environment 1200 may include multiple client device 1206, transportation matching system 102, vehicle subsystems 1208, and/or networks 1204.

This disclosure contemplates any suitable network 1204. As an example, and not by way of limitation, one or more portions of network 1204 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1204 may include one or more networks 1204.

Links may connect client device 1206, airport priority matching system 104, and vehicle subsystem 1208 to network 1204 or to each other. This disclosure contemplates any suitable links. In particular embodiments, one or more links include one or more wireline (such as for example Digital Subscriber Line (“DSL”) or Data Over Cable Service Interface Specification (“DOC SIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1200. One or more first links may differ in one or more respects from one or more second links.

In particular embodiments, the client device 1206 may be an electronic device including hardware, software, or embedded logic components or a combination of two or more such components and capable of carrying out the appropriate functionalities implemented or supported by client device 1206. As an example, and not by way of limitation, a client device 1206 may include any of the computing devices discussed above in relation to FIG. 11. A client device 1206 may enable a network user at the client device 1206 to access network 1204. A client device 1206 may enable its user to communicate with other users at other client devices 1206.

In particular embodiments, the client device 1206 may include a requester application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 1206 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 1206 one or more Hyper Text Markup Language (“HTML”) files responsive to the HTTP request. The client device 1206 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, transportation matching system 102 may be a network-addressable computing system that can host a transportation matching network. The transportation matching system 102 may generate, store, receive, and send data, such as, for example, user-profile data, concept-profile data, text data, transportation request data, GPS location data, provider data, requester data, vehicle data, or other suitable data related to the transportation matching network. This may include authenticating the identity of providers and/or vehicles who are authorized to provide transportation services through the transportation matching system 102. In addition, the transportation matching system 102 may manage identities of service requesters such as users/requesters. In particular, the transportation matching system 102 may maintain requester data such as driving/riding histories, personal data, or other user data in addition to navigation and/or traffic management services or other location services (e.g., GPS services).

In particular embodiments, the transportation matching system 102 may manage transportation matching services to connect a user/requester with a vehicle and/or provider. By managing the transportation matching services, the transportation matching system 102 can manage the distribution and allocation of resources from vehicle systems and user resources such as GPS location and availability indicators, as described herein.

The transportation matching system 102 may be accessed by the other components of network environment 1200 either directly or via network 1204. In particular embodiments, the transportation matching system 102 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the transportation matching system 102 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1206, or a transportation matching system 102 to manage, retrieve, modify, add, or delete, the information stored in data store.

In particular embodiments, the transportation matching system 102 may provide users with the ability to take actions on various types of items or objects, supported by the transportation matching system 102. As an example, and not by way of limitation, the items and objects may include transportation matching networks to which users of the transportation matching system 102 may belong, vehicles that users may request, location designators, computer-based applications that a user may use, transactions that allow users to buy or sell items via the service, interactions with advertisements that a user may perform, or other suitable items or objects. A user may interact with anything that is capable of being represented in the transportation matching system 102 or by an external system of a third-party system, which is separate from transportation matching system 102 and coupled to the transportation matching system 102 via a network 1204.

In particular embodiments, the transportation matching system 102 may be capable of linking a variety of entities. As an example, and not by way of limitation, the transportation matching system 102 may enable users to interact with each other or other entities, or to allow users to interact with these entities through an application programming interfaces (“API”) or other communication channels.

In particular embodiments, the transportation matching system 102 may include a variety of servers, sub-systems, programs, modules, logs, and data stores. In particular embodiments, the transportation matching system 102 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile (e.g., provider profile or requester profile) store, connection store, third-party content store, or location store. The transportation matching system 102 may also include suitable components such as network interfaces, security mechanisms, load balancers, failover servers, management-and-network-operations consoles, other suitable components, or any suitable combination thereof. In particular embodiments, the transportation matching system 102 may include one or more user-profile stores for storing user profiles for transportation providers and/or transportation requesters. A user profile may include, for example, biographic information, demographic information, behavioral information, social information, or other types of descriptive information, such as interests, affinities, or location.

The web server may include a mail server or other messaging functionality for receiving and routing messages between the transportation matching system 102 and one or more client devices 1206. An action logger may be used to receive communications from a web server about a user's actions on or off the transportation matching system 102. In conjunction with the action log, a third-party-content-object log may be maintained of user exposures to third-party-content objects. A notification controller may provide information regarding content objects to a client device 1206. Information may be pushed to a client device 1206 as notifications, or information may be pulled from client device 1206 responsive to a request received from client device 1206. Authorization servers may be used to enforce one or more privacy settings of the users of the transportation matching system 102. A privacy setting of a user determines how particular information associated with a user can be shared. The authorization server may allow users to opt in to or opt out of having their actions logged by the transportation matching system 102 or shared with other systems, such as, for example, by setting appropriate privacy settings. Third-party-content-object stores may be used to store content objects received from third parties. Location stores may be used for storing location information received from client devices 1206 associated with users.

In addition, the vehicle subsystem 1208 can include a human-operated vehicle or an autonomous vehicle. A provider of a human-operated vehicle can perform maneuvers to pick up, transport, and drop off one or more requesters according to the embodiments described herein. In certain embodiments, the vehicle subsystem 1208 can include an autonomous vehicle—e.g., a vehicle that does not require a human operator. In these embodiments, the vehicle subsystem 1208 can perform maneuvers, communicate, and otherwise function without the aid of a human provider, in accordance with available technology.

In particular embodiments, the vehicle subsystem 1208 may include one or more sensors incorporated therein or associated thereto. For example, sensor(s) can be mounted on the top of the vehicle subsystem 1208 or else can be located within the interior of the vehicle subsystem 1208. In certain embodiments, the sensor(s) can be located in multiple areas at once e.g., split up throughout the vehicle subsystem 1208 so that different components of the sensor(s) can be placed in different locations in accordance with optimal operation of the sensor(s). In these embodiments, the sensor(s) can include motion-related components such as an inertial measurement unit (“IMU”) including one or more accelerometers, one or more gyroscopes, and one or more magnetometers. The sensor(s) can additionally or alternatively include a wireless IMU (“WIMU”), one or more cameras, one or more microphones, or other sensors or data input devices capable of receiving and/or recording information relating to navigating a route to pick up, transport, and/or drop off a requester.

In particular embodiments, the vehicle subsystem 1208 may include a communication device capable of communicating with the client device 1206 and/or the airport priority matching system 104. For example, the vehicle subsystem 1208 can include an on-board computing device communicatively linked to the network 1204 to transmit and receive data such as GPS location information, sensor-related information, requester location information, or other relevant information.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
identifying, utilizing global positioning data, a plurality of provider devices within an airport boundary region;
determining, for the plurality of provider devices based on the global positioning data, a plurality of time metrics relative to an airport pickup location or a ranking order corresponding to an airport provider device tiered staging location;
prior to receiving a time priority airport transportation request, reserving a set of provider devices of the plurality of provider devices for airport time priority services based on the plurality of time metrics relative to the airport pickup location or the ranking order; and
in response to receiving the time priority airport transportation request from a priority requester device, selecting a provider device from a pool of available provider devices comprising the set of provider devices to match to the priority requester device.

2. The computer-implemented method of claim 1, further comprising:
identifying, utilizing the global positioning data, a first subset of the plurality of provider devices at an initial provider device staging location and a second subset of the plurality of provider devices at the airport provider device tiered staging location; and
determining the ranking order corresponding to the airport provider device tiered staging location based on an arrival order of the second subset of the plurality of provider devices at the airport provider device tiered staging location.

3. The computer-implemented method of claim 2, further comprising reserving the set of provider devices from the second subset of the plurality of provider devices based on an inverse order of the arrival order of the second subset of the plurality of provider devices.

4. The computer-implemented method of claim 3, further comprising in response to identifying a new provider device at the airport provider device tiered staging location, reserving the new provider device and releasing a provider device of the set of provider devices based on the ranking order.

5. The computer-implemented method of claim 4, further comprising:
determining a reserved time for a provider device of the set of provider devices; and
in response to determining that the reserved time exceeds a threshold reservation time, releasing the provider device from being reserved for the airport time priority services.

6. The computer-implemented method of claim 1, further comprising:
identifying a plurality of pre-dispatch provider devices dispatched to the airport pickup location;
determining time metrics relative to the airport pickup location for the plurality of pre-dispatch provider devices; and
reserving the set of provider devices from the plurality of pre-dispatch provider devices based on the time metrics for the plurality of pre-dispatch provider devices.

7. The computer-implemented method of claim 6, further comprising in response to determining, based on the global positioning data, that a pre-dispatch provider device of the set of provider devices is located within a threshold radius of the airport pickup location, releasing the pre-dispatch provider device from being reserved for the airport time priority services.

8. The computer-implemented method of claim 1, further comprising:
in response to receiving a flexible time delay airport transportation request from a flex requester device at the airport pickup location, dispatching a flex provider device to the airport pickup location; and
reserving the flex provider device for the airport time priority services based on a time metric of the flex provider device relative to the airport pickup location.

9. The computer-implemented method of claim 8, further comprising in response to receiving the time priority airport transportation request, selecting the flex provider device as the provider device to match to the priority requester device.

10. The computer-implemented method of claim 8, further comprising in response to determining that the flex provider device is within a threshold radius relative to the airport pickup location, releasing the flex provider device and matching the flex provider device to a requester device.

11. A system comprising:
at least one processor; and
a non-transitory computer readable storage medium comprising instructions that, when executed by the at least one processor, cause the system to:
identify, utilizing global positioning data, a plurality of provider devices within an airport boundary region;
determine, for the plurality of provider devices based on the global positioning data, a plurality of time metrics relative to an airport pickup location or a ranking order corresponding to an airport provider device tiered staging location;
prior to receiving a time priority airport transportation request, reserve a set of provider devices of the plurality of provider devices for airport time priority services based on the plurality of time metrics relative to the airport pickup location or the ranking order; and
in response to receiving the time priority airport transportation request from a priority requester device, selecting a provider device from a pool of available provider devices comprising the set of provider devices to match to the priority requester device.

12. The system of claim 11, further comprising instructions that, when executed by the at least one processor, cause the system to:
in response to identifying preliminary matches between the plurality of provider devices and a plurality of requester devices at the airport pickup location, dispatch the plurality of provider devices to the airport pickup location; and
reserve the set of provider devices from the plurality of provider devices based on the plurality of time metrics relative to the airport pickup location.

13. The system of claim 11, further comprising instructions that, when executed by the at least one processor, cause the system to:
identify a plurality of unavailable provider devices transporting requester devices to the airport boundary region;
determine time metrics relative to the airport pickup location for the plurality of unavailable provider devices; and
reserve the set of provider devices from the plurality of unavailable provider devices based on the time metrics relative to the airport pickup location.

14. The system of claim 11, further comprising instructions that, when executed by the at least one processor, cause the system to determine a number of provider devices to reserve in the set of provider devices by utilizing a prediction model to determine at least one of an estimated number of requester devices at the airport pickup location or an estimated number of provider devices to dispatch to the airport provider device tiered staging location.

15. The system of claim 11, further comprising instructions that, when executed by the at least one processor, cause the system to reserve the set of provider devices until detecting that one or more provider devices of the set of provider devices is within a threshold radius of the airport pickup location.

16. The system of claim 11, further comprising instructions that, when executed by the at least one processor, cause the system to utilize a hyperparameter model to select one or more hyperparameters comprising at least one of: a number of provider devices to reserve, a threshold reservation radius, or a threshold reservation time.

17. The system of claim 16, wherein the hyperparameter model comprises at least one of a simulator model, a machine learning model, or an objective function.

18. A non-transitory computer readable storage medium comprising instructions that, when executed by at least one processor, cause the at least one processor to:
identify, utilizing global positioning data, a plurality of provider devices within an airport boundary region;
determine, for the plurality of provider devices based on the global positioning data, a plurality of time metrics relative to an airport pickup location or a ranking order corresponding to an airport provider device tiered staging location;
prior to receiving a time priority airport transportation request, reserve a set of provider devices of the plurality of provider devices for airport time priority services based on the plurality of time metrics relative to the airport pickup location or the ranking order; and
in response to receiving the time priority airport transportation request from a priority requester device, select a provider device from a pool of available provider devices comprising the set of provider devices to match to the priority requester device.

19. The non-transitory computer readable storage medium of claim 18, further comprising instructions that, when executed by the at least one processor, cause the at least one processor to:
identify, utilizing the global positioning data, a first subset of the plurality of provider devices at an initial provider device staging location and a second subset of the plurality of provider devices at the airport provider device tiered staging location; and
determine the ranking order corresponding to the airport provider device tiered staging location based on an arrival order of the second subset of the plurality of provider devices at the airport provider device tiered staging location.

20. The non-transitory computer readable storage medium of claim 18, further comprising instructions that, when executed by the at least one processor, cause the at least one processor to:
identify a plurality of pre-dispatch provider devices dispatched to the airport pickup location;
determine time metrics relative to the airport pickup location for the plurality of pre-dispatch provider devices; and
reserve the set of provider devices from the plurality of pre-dispatch provider devices based on the time metrics for the plurality of pre-dispatch provider devices.
